(19) United States
(12) Patent Application Publication
(10) Pub. No.: US 2024/0186653 A1
(43) Pub. Date: Jun. 6, 2024

(54) ADVANCED MULTIFUNCTIONAL BATTERY SEPARATOR MEMBRANES FOR NOVEL LIQUID ELECTROLYTES AND METHODS OF USE THEREOF

(71) Applicants: TalosTech LLC, New Castle, DE (US); California Institute of Technology, Pasadena, CA (US)

(72) Inventors: Hansan Liu, Hockessin, DE (US); Chun-Wei Wu, Pasadena, CA (US); Xiaoping Lin, Hockessin, DE (US); Katherine T. Faber, Pasadena, CA (US)

(73) Assignees: TalosTech LLC, New Castle, DE (US); California Institute of Technology, Pasadena, CA (US)

(21) Appl. No.: 18/369,645

(22) Filed: Sep. 18, 2023

Related U.S. Application Data
(60) Provisional application No. 63/429,466, filed on Dec. 1, 2022.

(51) Int. Cl. H01M 50/446; H01M 10/054; H01M 50/403; H01M 50/434; H01M 50/491; H01M 50/494; H01M 50/497

(52) U.S. Cl. CPC H01M 50/446; H01M 10/054; H01M 50/403; H01M 50/434; H01M 50/491; H01M 50/494; H01M 50/497

(57) ABSTRACT

Separator membranes for ion batteries and methods of producing such separator membranes are disclosed herein. The separator membranes have vertically-aligned pores that have as small as submicron diameters at one or both membrane surfaces. The separator membranes may be fabricated via a novel and innovative bidirectional freeze-casting process that produces a temperature gradient in two directions. The separator membranes disclosed herein and fabricated by this method can be used in ion batteries, such as sodium ion batteries.

### CROSS-REFERENCE TO RELATED APPLICATIONS

This claims the benefit of the filing date of U.S. Provisional Application No. 63/429,466, filed Dec. 1, 2022, the entire content of which is incorporated by reference herein.

### FILED OF THE INVENTION

The present invention relates to the field of battery technologies, in particular to permeable battery separator membranes for use with novel liquid electrolyte batteries, such as sodium ion batteries and other novel battery technology.

### BACKGROUND

As developed nations push for replacement of fossil fuels with renewable and green energy, the demand for battery storage has grown exponentially and is projected to continue to do so [Roberts, “Why lithium-ion batteries are so important” in Canary Media (April 14, 2021) available at https://www.canarymedia.com/articles/batteries/why-lithium-ion-batteries-are-so-important]. An electric battery generally consists of one or more electrochemical cells with external connections for providing electric power to electrical devices. Of particular importance are rechargeable batteries, which can be discharged and recharged multiple times. Typical rechargeable batteries found in the art include lead-acid batteries, such as those found in motor vehicles, and lithium-ion batteries found in mobile devices. However, lead-acid batteries tend to be very heavy, are expensive, exhibit considerable loss of capacity, and present an environmental hazard due to their lead content. What's more, and while lithium ion batteries are currently the most advanced and deployed power sources, concerns have been raised in recent years on their sustainability due to lithium being a comparatively rare element and safety issues since lithium-ion batteries are extremely sensitive to high temperatures and inherently flammable. As such, there exists a need to develop new electrolyte battery technologies beyond lithium in order to overcome the limitation of lithium ion batteries in terms of performance, cost, safety, and environmental footprint.

One of the critical components in liquid electrolyte batteries are the separator membranes, which generally are permeable membranes placed between the anode and cathode of the battery. Separator membranes may be made from a variety of materials, such as nonwoven fibers, polymers, ceramics, rubber, wood/paper, and other materials. The separator membranes function to keep the electrodes apart to prevent electrical short circuits while permitting transport of the ionic charge carriers. Importantly, the separator membranes must be sufficiently microporous to allow efficient passage of the ionic charge carriers, but must also withstand the high tension during battery construction. In addition to sufficient porosity and strength, the separator membranes must be chemically and electrochemically stable with regard to the electrolyte and electrode materials.

One of the alternative electrolyte battery technologies that is being explored is the sodium ion battery technology, which found in greater abundance than lithium and represents a cost-effective solution for distributed or household-based renewable energy sources. Sodium ion batteries and other new battery chemistry, such as magnesium and aluminum, require new electrolytes due to the differences in operating voltage, working ions, solvation environments, or charge transport requirements. However, these new battery technologies lack suitable separator membranes [e.g., Walter “Challenges and benefits of post-lithium ion batteries” New J. Chem. 44:1677 (2020)]. Indeed, accurate assessment of potential new electrolyte battery chemistries and architectures, such as sodium ion battery technologies, are complicated by the fact that membrane separators used in lithium and other more conventional battery technologies cannot readily be incorporated into the design of these new batteries. Using separator membranes that are incompatible with the battery chemistry lead to poor ionic transport and wettability issues, which can cause inhomogeneous distribution of current density and instability of the electrolyte interface. While some in the art have attempted to use paper or thick glass fiber membranes in sodium ion batteries and other novel electrolyte technologies, these separator membranes are far too thick and not practical for commercial applications.

Thus, there is an urgent and unmet need for advanced separators to enable new battery chemistries and architectures using non-traditional liquid electrolytes.

### SUMMARY OF THE INVENTION

Described herein is a novel and innovative bidirectional freezing method of fabricating separator membranes for use in ion batteries and, in particular, ion batteries with non-traditional chemistries, such as sodium ion batteries. The method combines tape casting and freeze casting to produce thin, porous separator membranes, which themselves are an improvement over the art. The novel and innovative separator membranes contain vertically-aligned pores that, in preferred embodiments, have pore diameters of less than about 5 μm at one or both membrane surfaces. In more preferred embodiments, the vertically-aligned pores have diameters of less than about 1μm at one or both membrane surfaces. The present method provides novel solutions to the problems discussed above to enable the fabrication of separator membranes produced that exhibit high electrolyte uptake, superior ionic conductivity, improved capacity/cycling performance, improved wettability, and increase durability compared to existing separator membranes used with non-traditional ion battery technology (e.g., SIBs).

In one aspect, provided herein is a separator membrane produced from a freeze-cast solution. The separator membrane includes at least one polymer and has a total porosity of at least about 50% along with a plurality of vertically-aligned pore structures. Moreover, greater than about 75% of the vertically-aligned pore structures will have a height that is greater than its diameter, and each of the pore structures have a diameter that is less than about 2 μm at a membrane surface.

In preferred embodiments, greater than about 95% of the vertically-aligned pore structures will have a height that is greater than its diameter, and each of the pore structures have a diameter that is less than about 1 μm at a membrane surface. In other embodiments, greater than 99% of the vertically-aligned pore structures comprise a height that is greater than their diameter and/or the vertically-aligned pore structures have a pore diameter that is less than about 1 μm at the top membrane surface, the bottom membrane surface, or both the top membrane surface and bottom membrane surface.

In one embodiment, the freeze-cast solution comprises between about 10% by wt and about 40% by wt polymer; preferably, it is between about 15% by wt and about 25% by wt polymer. The polymer may be selected from polyvinylidene fluoride (PVDF), poly(vinylidene fluoride-co-hexafluoropropylene (PVDF-HFP), polyimide, polyamic acid, polyolefin, polytetrafluoroethylene, polyvinyl chloride, polypropylene, polyethylene, polyethylene terephthalate, polyacrylonitrile, or a combination of polymers. In a particular embodiment, the polymer is PVDF-HFP.

The separator membrane of the invention described herein may also include ceramic particles, such as, but not limited to SiO₂, Al₂O₃, TiO₂, ZrO₂, MgO, Li₇La₃Zr₂O₁₂ (LLZO), or a combination of any one of these ceramic particles. In some embodiments, the freeze-cast solution comprises between about 0.5% by wt and about 25% by wt ceramic particles, or between about 0.5% by wt and about 10% by wt ceramic particles. In one embodiment, the freeze-cast solution comprises between about 0.75% by wt and about 3% by wt Al₂O₃ or between about 8% by wt and about 16% by wt tetraethyl orthosilicate (TEOS).

In other embodiments, the separator film comprises a polymer matrix and the ceramic particles were embedded into the polymer matrix by infiltration following freeze casting. The ceramic particles may be selected from among SiO₂, Al₂O₄, TiO₂, ZrO₂, MgO, Li₇La₃Zr₂O₁₂ (LLZO), and a combination thereof. In some embodiments, the membrane thickness is between about 10 μm to about 100 μm; preferably, it is between about 20 μm to about 50 μm. In some aspects, the total porosity of the separator membrane is at least about 60%. The separator membrane may have a tensile strength of at least about 5 MPa according to ASTM-D882 and/or a MacMullin number of less than about 5 in an ionic liquid. In some embodiments, the separator membrane is disposed within an ion battery cell, such as a sodium ion battery cell.

Another aspect of the invention features a separator membrane produced from a freeze-cast solution that includes a total porosity of at least about 60%, a thickness of about 10 μm to about 100 μm, and a plurality of vertically-aligned pore structures. Each of the vertically-aligned pore structures will have a pore diameter of less than about 1 μm on at least one membrane surface, and greater than about 75% of the vertically-aligned pore structures comprise a height that is greater than their diameter. Moreover, the freeze-cast solution comprises between about 10% by wt and about 40% by wt polymer selected from the group consisting of polyvinylidene fluoride (PVDF), poly(vinylidene fluoride-co-hexafluoropropylene (PVDF-HFP), polyimide, polyamic acid, polyolefin, polytetrafluoroethylene, polyvinyl chloride, polypropylene, polyethylene, polyethylene terephthalate, and polyacrylonitrile, and a combination thereof. For instance, in one particular embodiment, the polymer is PVDF-HFP.

In some embodiments, greater than about 95% of the vertically-aligned pore structures comprise a height that is greater than their diameter. In other embodiments, the separator membrane comprises a top surface and a bottom surface, wherein each of the top surface and the bottom surface comprise a plurality of pores having a diameter of less than about 1 μm. In another embodiment, the separator membrane includes ceramic particles, which can be added in the freeze-cast solution at a concentration of between about 0.5% by wt and about 25% by wt and/or embedded into the polymer matrix of the separator film by infiltration following freeze casting. In either case, the ceramic particles may include SiO₂, Al₂O₄, TiO₂, ZrO₂, MgO, garnet Li₇La₃Zr₂O₁₂, or a combination thereof. In some embodiments, the vertically-aligned pore structures comprise a plurality of secondary pores.

Another aspect of the invention features a method of producing a separator membrane with vertically-aligned pore structures, such as the separator membranes described above. The method includes the steps of (a) preparing a polymer solution comprising at least one polymer and at least one solvent; (b) tape casting the polymer solution to produce a tape-cast polymer film; (c) freeze casting the tape cast polymer film on a freezing stage at a temperature from about 20° C. to about −200° C. to provide a freeze-cast polymer film; and (d) extracting the solvent from the freeze-cast polymer film to produce a separator membrane with vertically aligned pores.

In one embodiment, the polymer solution is heated until homogeneous and the tape casting comprises disposing the polymer solution on a substrate, which can be selected from the group consisting of aluminum, copper, glass, and stainless steel. In another embodiment, the tape casting is done with a doctor blade. In yet another embodiment, the polymer film is between about 1 mil and about 15 mil thick. In still another embodiment, the freeze-casting step includes disposing the tape cast polymer film and substrate on the freezing stage. The freezing stage may be made of a thermally conductive material having a thermal conductivity of between about 80 W/m·K and about 300 W/m·K. An suitable example of a freezing stage is an aluminum freezing stage.

In another embodiment of the method, the freezing stage is pre-chilled at a temperature range from about −20° C. to about −200° C.; preferably, it is pre-chilled at a temperature range from about −40° C. to about −190° C. The freezing stage may be pre-chilled with dry ice or liquid nitrogen, or by a thermoelectric cooler. In some embodiments, the method includes placing a spacing component on one end of the freezing stage so that the tape-cast polymer film and substrate are disposed on the freezing stage with one end of the substrate contacting the freezing stage directly with an opposite end disposed on the spacing component to create an angled air wedge between the substrate and freezing stage. In some embodiments, the angled air wedge comprises an upward angle between about 0° and about 30°.

In one embodiment, the method includes disposing a top cold finger (pre-chilled at a temperature from about −20° C. to about −200° C.) on the polymer film during the freeze-casting step. In another embodiment, the method includes the additional step of soaking the freeze-cast separator membrane in a solution that serves as a source of ceramic particles for a period of time (e.g., at least about 15 minutes). Some aspects of the method include subjecting the freeze-cast separator membrane to a sol-gel process before and/or after soaking the freeze-cast separator membrane in the solution containing ceramic particles.

In another embodiment, the polymer solution includes between about 10% by wt and about 40% by wt polymer, such as, but not limited to polyvinylidene fluoride (PVDF), poly(vinylidene fluoride-co-hexafluoropropylene (PVDF-HFP), polyimide, polyamic acid, polyolefin, polytetrafluoroethylene, polyvinyl chloride, polypropylene, polyethylene, polyethylene terephthalate, polyacrylonitrile, and a combination thereof. In yet another embodiment, the polymer solution comprises ceramic particles at a concentration of between about 1% by wt and about 25% by wt. The ceramic particles may be selected from the group consisting of SiO₂, Al₂O₃, TiO₂, ZrO₂, MgO, garnet Li₇La₃Zr₂O₁₂, and a combination thereof (e.g., between about 0.75% by wt and about 3% by wt Al₂O₃ or between about 8% by wt and about 16% by wt tetraethyl orthosilicate (TEOS)). In another embodiment, the polymer solution further comprises a solvent having a boiling point less than 260° C. and a relative energy difference with the polymer of less than 1.

These and other features and advantages of the present disclosure will become better understood with regard to the following description, appended claims, and accompanying drawings.

### BRIEF DESCRIPTION OF THE DRAWINGS

FIG. 1 is a diagram of an exemplary sodium ion battery.

FIG. 2 is a cross sectional scanning electron microscope (SEM) image of a separator membrane fabricated from 20% wt PVDF-HFP and 8% TEOS that did not undergo sol-gel treatment (aligned with hot face on top).

FIGS. 3A-3C are diagrams of the tape casting and freeze-casting assemblies. FIG. 3A shows the tape casting of a polymer film onto a substrate.

FIG. 3B is a diagram of a one-sided bidirectional freeze-casting assembly.

FIG. 3C is a diagram of a two-sided bidirectional freeze-casting assembly.

FIG. 4 is a process flow chart for fabrication of exemplary PVDF-HFP separator membranes made with dimethyl sulfoxide (DMSO) (left boxes) and composite PVDF-HFP/SiO₂ separator membranes made according to the co-solvent method (middle boxes) and the infiltration method (right boxes).

FIG. 5 is a diagram of an exemplary freeze-casting assembly.

FIG. 6 are SEM images of a PVDF separator membrane microstructure at the glass face (panel a), at the steel face (panel b), and the cross-section showing the through-thickness (panel c). Magnification bar is 40 μm.

FIG. 7 are SEM images of a PVDF-HFP separator membrane microstructure at the cold face (panel a) and at the hot face (panel b); a 1.05 wt % alumina-KD-PVDF-HFP separator membrane microstructure at the cold face (panel c) and at the hot face (panel d); and a 1.5 wt % alumina-KD-PVDF-HFP separator membrane microstructure at the cold face (panel e) and at the hot face (panel f). Magnification bar is 40 μm for the main panels and 10 μm for the insets.

FIG. 8 are cross-sectional SEM images of a PVDF-HFP membrane (panels a and b), a 1.05 wt % alumina-KD-PVDF-HFP separator membrane (panels c and d), and a 1.5 wt % alumina-KD-PVDF-HFP separator membrane (panels e and f). Magnification bar is 40 μm (panels a, c, e) or 10 μm (panels b, d, f).

FIG. 9 are cross-sectional SEM images of a 1.05 wt % alumina-PVDF-HFP separator membrane (panel a), 1.5 wt % alumina-PVDF-HFP separator membrane (panel b), and a 2.25 wt % alumina-PVDF-HFP separator membrane (panels c and e). Panel d is an EDS mapping for aluminum of the 2.25 wt % alumina-PVDF-HFP separator membrane. Magnification bar is 10 um (panels a-c), 25 μm (panel d), or 4 μm (panel e).

FIG. 10 are cross sectional SEM images of a SiO₂-coated PVDF-HFP separator membrane at increasing magnifications. Magnification bar is 10 μm (panels a and c) or 2 μm (panel b).

FIG. 11 is a graph showing porosities of the various separator membranes after 24 hours of soaking. The y-axis is percent porosity.

FIG. 12 are images shown in the contact angles of different separator membranes in three different electrolytes for sodium ion batteries.

FIG. 13 is a bar graph showing the electrolyte uptake of different separator membranes in three different electrolytes for sodium ion batteries. The y-axis is percentage of electrolyte uptake.

FIG. 14 is a bar graph showing ionic conductivity of different separator membranes in organic and ionic liquid electrolytes. The y-axis is the ionic conductivity in mS/cm. S, Siemens.

FIG. 15 is a bar graph showing the MacMullin numbers of different separator membranes in organic and ionic liquid electrolytes. The MacMullin number is shown on the y-axis.

FIG. 16 is a line graph showing the thermal stability of the PVDF-HFP and ceramic-modified PVDF-HFP separator membranes. The values are presented as a function of heat treatment temperature for 30 minutes as determined by area change. The x-axis is the temperature in ° C., whereas the y-axis is the percentage of area change.

FIG. 17 is a diagram and photograph showing the sample dimensions (left) and mechanical testing setup (right) for tensile strength.

FIG. 18 are graphs showing the cyclic voltammetry (left panel) and charge-discharge curves (right panel) at different current rates of NaV(PO₄)₃/NaTi₂(PO₄)₃ full cell in 1M NaClO₄ in PC/EC electrolyte. The x-axis is voltage (V), whereas the y-axis is current density (mA/cm²) (left panel). The x-axis is S-capacity, whereas the y-axis is voltage (volts) (right panel).

FIG. 19 are charge-discharge curves and rate performance of coin cells using filter paper as compared to bidirectional freeze-cast PVDF-HFP separator membranes in organic and ionic liquid electrolytes. The x-axis is S-capacity, whereas the y-axis is voltage (volts).

FIG. 20 are graphs showing the cycling performance of freeze-cast PVDF-HFP as compared to filter paper in organic electrolyte (top panel) or ionic liquid electrolyte (bottom panel).

FIG. 21 are charge-discharge curves and rate performance of coin cells using filter paper as compared to bidirectional freeze-cast Al₂O₃-filled PVDF-HFP in organic and ionic liquid electrolytes. The x-axis is S-capacity, whereas the y-axis is voltage (volts).

FIG. 22 are SEM images of a 15 wt % PVDF-HFP separator membrane microstructure at the cross-section (panel a), cold face (panel b); hot face (panel c); a 20 wt % PVDF-HFP separator membrane microstructure at the cross-section (panel d), cold face (panel e); hot face (panel f); and a 25 wt % PVDF-HFP separator membrane microstructure at the cross-section (panel g), cold face (panel h); hot face (panel i). Magnification bar is 10 μm (panels a, d, g) or 4 μm (panels b, c, e, f, h, i).

FIG. 23 are graphs showing the stress-strain curves (panel a) and tensile strengths and porosities (panel b) of PVDF-HFP membranes made with different polymer concentrations. The insert shows the initial region of the curves (panel a, box). The x-axis in panel a is the percent strain, whereas the y-axis is the stress (MPa). The x-axis in panel b is the polymer concentration (wt %), whereas the left y-axis is the tensile strength (MPa) and right y-axis is percent porosity.

FIG. 24 are SEM images of a D80T0 separator membrane microstructure at the cross-section (panel a), cold face (panel b); and hot face (panel c); a D72T8 separator membrane microstructure at the cross-section (panel d), cold face (panel e); and hot face (panel f); and a D64T16 separator membrane microstructure at the cross-section (panel g), cold face (panel h); and hot face (panel i). Magnification bar is 10 μm (panels a, d, g) or 4 μm (panels b, c, e, f, h, i).

FIG. 25 are cross-sectional SEM images of a D72T8 separator membrane fabricated with a sol-gel step (panel a) or without a sol-gel step (panel b). Magnification bar is 2 μm.

FIG. 26 are graphs showing the FTIR spectra for D80T0 separator membrane (top), a D72T8 separator membrane (middle), and a D64T16 separator membrane (bottom). Column (a) are FTIR spectra on the cold face, whereas column (b) are FTIR spectra on the hot face. The x-axis represents wavenumber (cm⁻¹), whereas the y-axis is absorbance.

FIG. 27 are SEM images of a D80T0 separator membrane microstructure at the cross-section (panel a), cold face (panel b); and hot face (panel c); a D80T0(inf) separator membrane microstructure at the cross-section (panel d), cold face (panel e); and hot face (panel f); and the EDS Si mapping results of D80T0 (inf) at the cross-section (panel g), cold face (panel h); and hot face (panel i). Magnification bar is 10 μm (panels a, d, g-i) or 4 μm (panels b, c, e, f).

FIG. 28 are SEM images of a D72T8 separator membrane microstructure at the cross-section (panel a), cold face (panel b); and hot face (panel c); a D72T8 (inf) separator membrane microstructure at the cross-section (panel d), cold face (panel e); and hot face (panel f); and the EDS Si mapping results of D72T8 (inf) at the cross-section (panel g), cold face (panel h); and hot face (panel i). Magnification bar is 10 μm (panels a, d, g-i) or 4 μm (panels b, c, e, f).

FIG. 29 are graphs showing the FTIR spectra for D80T0 separator membrane (top), a D80T0 (inf) separator membrane (second), a D72T8 separator membrane (third), and a D72T8 (inf) separator membrane (bottom). Column (a) are FTIR spectra on the cold face, whereas column (b) are FTIR spectra on the hot face. The x-axis represents wavenumber (cm⁻¹), whereas the y-axis is absorbance.

FIG. 30 are box graphs showing the tensile strengths (panel a) and strain-to-failure (panel b) of separator membranes fabricated via the co-solvent method without sol-gel (open circles), the co-solvent method with sol-gel (open boxes), and infiltration method (solid boxes). The x-axis is the TEOS content in wt %, whereas the y-axis is either tensile strength (MPa) or strain-to-failure percentage.

FIG. 31 are images shown in the contact angles of four different freeze-cast separator membranes in four different electrolytes.

FIG. 32 is a bar graph showing electrolyte uptake of different freeze-cast separator membranes in different electrolytes. The y-axis represents the percentage of electrolyte uptake.

FIG. 33 is a bar graph showing ionic conductivity of different freeze-cast separator membranes in organic versus ionic liquid electrolyte. The y-axis represents ionic conductivity in mS/cm.

FIG. 34 is a bar graph showing the MacMullin numbers of different freeze-cast separator membranes in organic versus ionic liquid electrolyte.

FIG. 35 are charge-discharge curves of NVP/NT sodium ion battery coin cells made by freeze-cast separators and either a carbonate electrolyte (top) or ionic liquid electrolyte (bottom).

FIG. 36 is a bar graph showing the rate performance (capacity retention at 5 C vs 0.5 C) of the sodium ion batteries with different separator membranes in either organic electrolyte or ionic liquid electrolyte.

FIG. 37 are SEM images of a D80T0 separator membrane fabricated with one-sided freeze casting viewed at the cross-section (panel a), cold face (panel b); and hot face (panel c); a D80T0 separator membrane fabricated with two-sided freeze casting viewed at the cross-section (panel d), stage face (panel e); and plate face (panel f); and a D80T0 separator membrane fabricated with two-sided freeze casting followed by infiltration viewed at the cross-section (panel g), stage face (panel h); and plate face (panel i). Magnification bar is 20 μm (panel g), 10 μm (panels a, b), 4 μm (panels b, c, e, f), or 2 μm (panels h, i).

FIG. 38 are SEM images of a D72T8 separator membrane fabricated with one-sided freeze casting viewed at the cross-section (panel a), cold face (panel b); and hot face (panel c); and a D72T8 separator membrane fabricated with two-sided freeze casting followed by infiltration viewed at the cross-section (panel d), stage face (panel e); and plate face (panel f). Magnification bar is 20 μm (panel d), 10 μm (panel a), 4 μm (panels b, c), or 2 μm (panels e, f).

FIG. 39 is a flow chart summarizing the freeze-casting process to fabricate PVDF separator membranes using dry ice for the cooling temperature.

FIG. 40 are SEM images of PVDF-HFP separator membranes freeze-cast by using dry ice to cool the freezing stage and using spacer elements of different thicknesses (top row, 1.62 mm spacer; bottom row, 2.68 mm spacer). Magnification bar is 10 μm.

FIG. 41 is a photograph of an exemplary thermoelectric cooling (TEC) system for lab-scale bidirectional freeze casting.

FIG. 42 is a flow chart summarizing the freeze-casting process using the TEC system.

### DETAILED DESCRIPTION

Described herein is a novel and innovative bidirectional freeze-casting process that enables the production of non-traditional, tailor-made battery separator membranes with vertically-aligned pore structures capable of addressing the above-discussed wettability and ionic transport issues for electrolyte chemistries, such as electrolyte chemistries used with sodium ion batteries (SIBs). The bidirectional freeze-casting process includes the steps of solution preparation, tape casting the membrane solution, freeze casting, and solvent extraction. In preferred embodiments, the method includes ceramic (e.g., silica or alumina nanoparticles) infiltration into the polymer matrix. The freeze-casting step involves the use of a thermally conductive freezing stage, such as aluminum, and a tape-cast substrate (e.g., aluminum, glass, copper, etc). A mixture of polymer and solvent is tape cast over the substrate, which is then contacted to the pre-chilled/temperature controlled freezing stage. The freeze-casting assembly may include a spacer element at one end of the freezing stage so that the tape-cast substrate is placed onto the stage with a leading edge in direct contact with the “cold finger” of the freezing stage, while the opposite edge rests on the spacer to create an angled air wedge between the tape-cast substrate and freezing stage. The combination of the differences in temperature between the tape-cast substrate and freezing stage and air wedge enables a temperature gradient in two directions.

The separator membranes produced by this method are themselves novel and innovative. The polymer/solvent mixture is bidirectionally frozen to contain a plurality of vertically-aligned pore structures. In some embodiments, these vertically-aligned pore structures are populated with a plurality of secondary pores to produce a hierarchical pore structure. As noted below, the bidirectional method can be combined with control of the freezing velocity and temperature gradient to create pores having an average diameter that is less than 1 μm on at least one membrane face, which reduces or prevents electrode particle penetration. The separator membranes produced herein exhibit high electrolyte uptake, superior ionic conductivity, improved capacity/cycling performance, improved wettability, and increase durability compared to existing separator membranes used with non-traditional ion battery technology (e.g., SIBs).

The compositions and methods disclosed herein will be described in more detail below.

### Definitions

Unless defined otherwise, all technical and scientific terms used herein have the same meaning as those commonly understood by one of ordinary skill in the art to which this invention belongs. Standard techniques are used unless otherwise specified. Although methods and materials similar or equivalent to those described herein can be used in the practice or testing of the present disclosure, suitable methods and materials are described below. The materials, methods and examples are illustrative only, and are not intended to be limiting. All publications, patents and other documents mentioned herein are incorporated by reference in their entirety.

As used herein, the singular forms “a,” “an,” and “the” include the plural referents unless the context clearly indicates otherwise.

The term “about” refers to the variation in the numerical value of a measurement, e.g., weight percentage, time, temperature, concentration, etc., due to typical error rates of the device used to obtain that measure. In one embodiment, the term “about” means within 5% of the reported numerical value, preferably, the term “about” means within 3% of the reported numerical value.

The term “ceramic” as used herein refers to an inorganic, non-metallic oxide, nitride, or carbide material. “Ceramics” can be classified as oxides, such as alumina, beryllia, ceria, zirconia; non-oxides, such as carbide, boride, nitride, silicide; and composites, such as particular reinforced combinations of oxides and nonoxides.

The term “compatible solvent” as used herein refers to a solvent that is compatible with a particular polymer according to the Hansen space whereas the relative energy difference of the system is less than 1.

The term “infiltration” as used herein to refer to the “infiltration” of ceramic particles means that the ceramic particles are embedded into the polymer matrix or structure of the separator membrane via a sol-gel or other similar process. “Infiltrated” or embedded particles are distinct from particles coated on only the surfaces of the polymer matrix.

The term “MacMullin number” as used herein refers to a parameter for determining the quality of a separator in terms of ionic conductivity when the separator is soaked with an electrolyte.

The term “tortuosity” as used herein to refer to ion battery technology is a parameter used to correlate electrode microstructure with battery or separator membrane performance. “Tortuosity” is the fraction of the shortest pathway through a porous structure and the Euclidean distance between the starting and end point of that pathway.

The term “vertically-aligned” as used herein to refer to membrane pore structures means that the majority of pore structures will have a pore height that is greater than the pore diameter. Further, a “vertically-aligned” pore structure refers herein to a vertical axis along the pore height that is from about 60 degrees to about 120 degrees in relation to either the top face or the bottom face of the polymeric membrane.

The term “wettability” is the ability of a liquid to maintain contact with a solid surface and is measured as the contact angle of the liquid at the surface of the membrane.

### Separator Membrane Compositions

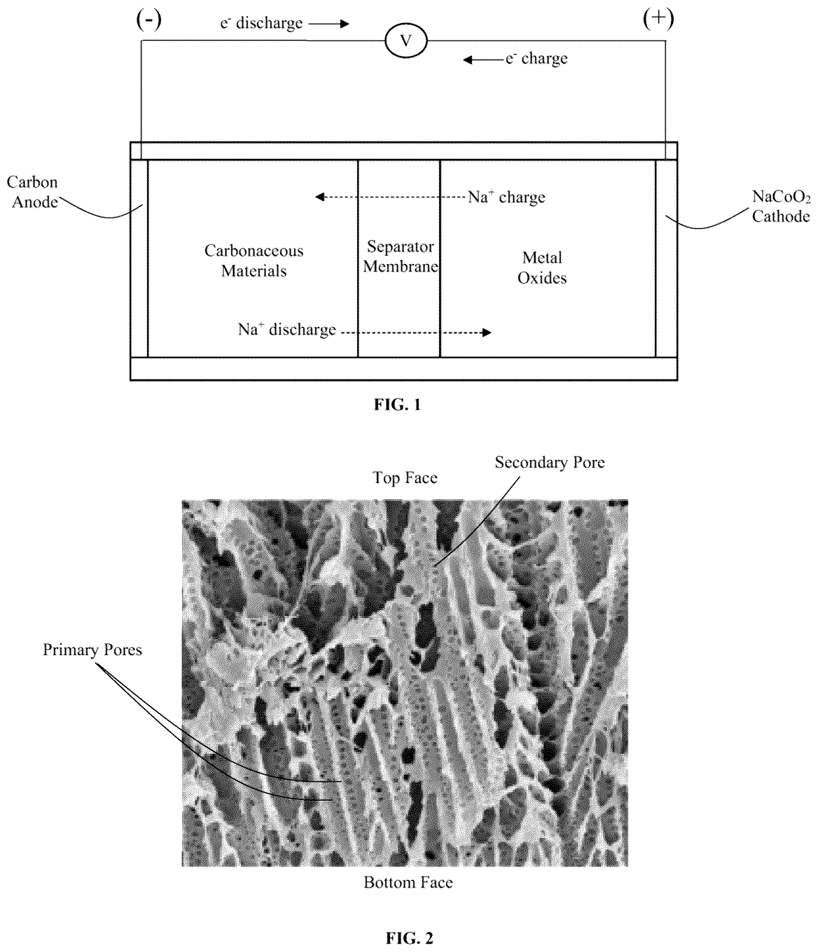

Described herein are battery separator membranes for use in batteries utilizing electrolyte chemistries, such as, but not limited to sodium-ion batteries. Generally, the separator membranes of the present disclosure will be made from a polymeric material and will have a vertically aligned pore structure, which improve wettability and ionic transport of the battery design. The separator membrane is typically disposed between the anode and cathode of an electrolyte-based battery cell, such as a sodium-ion battery (see FIG. 1). The cathode may be based on a metal, such as an alkali metal (e.g., sodium cobalt oxide), while the anode may be based on a carbonaceous material, such as graphite. During charging, sodium ions are extracted from the cathode, pass through the separator membrane, and are inserted into the anode while electrons travel through the external circuit. The reverse occurs during discharging. Preferred electrolytes include metal salts, such as, but not limited to sodium hexafluorophosphate and sodium perchlorate; organic carbonates, such as, but not limited to propylene carbonate/ethylene carbonate; ionic liquids, such as, but not limited to NaFSI/(PYR₁₃)FSI; water-in-salt solutions, such as, but not limited to high concentrated sodium perchlorate in water.

One of the important aspects of suitable separator membranes is wettability. As one having ordinary skill in the art would appreciate, wettability is important for the operating characteristics of the battery as suitable separator membranes should exhibit efficient electrolyte absorption and retention. Moreover, the separator membrane should be sufficiently ion-selective to enable efficient transport of the metal ions during battery charging and discharging. As battery electrolyte chemistries are being developed as an alternative to the lithium-ion batteries, it is becoming increasingly important to develop new separator membranes that are compatible with the electrolyte chemistries and overcome the current limitations of filter paper or thick glass fiber membranes as discussed above. Suitable separator membranes will have good wettability and ion transport while exhibiting sufficient tensile strength and resistance to degradation.

The separator membranes described herein can be made from a suitable polymer material or a combination of suitable polymer materials, such as but not limited to, polyvinylidene fluoride (PVDF), poly(vinylidene fluoride-co-hexafluoropropylene) (PVDF-HFP), polyimide, polyamic acid, polyolefin, polytetrafluoroethylene, polyvinyl chloride, polypropylene, polyethylene, polyethylene terephthalate, and polyacrylonitrile, and may have a thickness of about 10 μm to about 100 μm; more preferably, or about 20 μm to about 70 μm, or about 20 μm to about 60 μm, or about 10 μm to about 50 μm, or about 20 μm to about 50 μm. Moreover, the separator membranes will have vertically-aligned primary pore structures and, preferably, ceramic-embedded/coated microstructures that impart to the membrane decreased pore tortuosity, which increases ionic conductance, and enhanced wettability. In some embodiments, the vertically-aligned primary pores will contain secondary, smaller pores to produce a hierarchical pore structure. These pore structures are accomplished by subjecting a polymer-solvent system to a bidirectional freeze-casting process as will be explained in further detail below.

The separator membranes are produced from freeze casting a polymer solution to create a freeze-cast film. To prepare this solution, the polymer may be first admixed with a solvent at a polymer concentration of about 1% by wt to about 75% by wt; preferably, between about 10% by wt and about 50% by wt, or between about 10% by wt and about 40% by wt, or between about 10% by wt and about 35% by wt, e.g., 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35 by wt. Therefore, the separator membrane is said to be produced from a freeze-cast polymer mixture or solution containing a concentration of polymer in the range from about 1% to 75% by wt; preferably between about 15% and about 25% by wt. In other words, the identified concentration is the concentration of the polymer in the mixture or solution prior to freeze casting rather than the final concentration of polymer in the separator membrane. In one particular embodiment, the separator membrane is said to be produced from a freeze-cast polymer solution containing a concentration of about 15% by wt, 20% by wt, or 25% by wt (e.g., PDVF-HFP in DMSO).

The separator membranes disclosed herein will generally include a polymer matrix having a plurality of vertically (or directionally) aligned primary pore structures that form a porous layer for enabling ion transport. When viewed through the cross-section of the separator membrane, the plurality of the primary pores will have a pore height that is greater than the pore diameter. In some embodiments, a plurality of the primary pores will have a height that is at least about 1.5-fold or at least about 2-fold greater than the pore diameter. In other embodiments, a plurality of the primary pores will have a height that is at least about 3-fold greater than the pore diameter, or at least about 4-fold greater than the pore diameter.

The vertically-aligned primary pore structures may be described as having a vertical axis (i.e., an axis along the height of the pore) that is generally oriented from the top face to the bottom face through the cross section of the separator membrane. As one having ordinary skill in the art would readily appreciate, the top face of the separator membrane refers to the top surface of the separator membrane as viewed through the cross section of the separator membrane (e.g., via SEM), while the bottom face of the separator membrane refers to the bottom surface. While the vertical axis of the primary pore structures may be substantially perpendicular to the plane of the top face or the bottom face of the separator membrane (i.e., about 90°), the vertical axis of the primary pore structures may vary significantly from perpendicular, ranging anywhere from about 35° to about 145° in relation to the plane of the top face or the bottom face of the separator membrane; preferably, the vertical axis of the primary pore structures may be oriented from about 60° to about 120° in relation to the plane of the top face or the bottom face of the separator membrane, or between about 70° and about 110° in relation to the plane of the top face or the bottom face of the separator membrane, or between about 75 and about 105 in relation to the plane of the top face or the bottom face of the separator membrane.

In some embodiments, the vertically-aligned pore structure will be formed by the majority of the pores in the polymer structure of the separator membrane. In preferred embodiments, the vast majority of pores will have a height that is greater than its diameter, e.g., greater than about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.5%, or more of pores will have a height that is greater that its diameter. For instance, in one embodiment, greater than about 90% of the pores will have a height that is greater than its diameter, or greater than 95% of the pores will have a height that is greater than its diameter, or greater than 99% of pores will have a height that is greater than its diameter, or between about 80% and about 100% of pores will have a height that is greater than its diameter, or between about 90% and about 100% of pores will have a height that is greater than its diameter, or between about 95% and about 100% of pores will have a height that is greater than its diameter. An example of the vertically-aligned pore structure of the separator membranes described herein is shown in FIG. 2.

For the most efficient ion transport without cell shorting, it is desirable to produce separator membranes with vertically aligned pores that have diameters of less than about 5 μm, e.g., 5 μm, 4 μm, 3 μm, 2 μm, 1 μm, or less at one or more membrane surfaces. In other words, while the portion of a vertically-aligned pore that spans the membrane interior may be larger, the portion of the vertically aligned pore that appears on one or both of the surfaces of the membrane will preferably have a diameter of less than about 5 μm, preferably less than about 2 μm, more preferably, less than about 1 μm. As such, one or both membrane surfaces will have a plurality of pores, wherein the pores will have a diameter of less than about 5 μm, preferably less than about 2 μm, more preferably, less than about 1 μm. In some embodiments, both membrane surfaces will have a plurality of pores, wherein the pores will have a diameter of less than about 5 μm, preferably less than about 2 μm, more preferably, less than about 1 μm. For instance, in one particular embodiments, one of the surfaces of the separator membrane includes a plurality of pores, each of which having a diameter of less than about 1 μm. In another embodiments, both surfaces of the separator membrane includes a plurality of pores, each of which having a diameter of less than about 1 μm.

To confer good ion transfer properties to the separator membrane, it may be desirable to have a total porosity of at least about 50%, e.g., 50%, 51%, 52%, 53%, 54%, 55%, 56%, 57%, 58%, 59%, 60%, 61%, 62%, 63%, 64%, 65%, 66%, 67%, 68%, 69%, 70% or more. In a preferred embodiment, the porosity of the separator membrane is at least about 55% or at least about 60%. It may also be desirable to have an upper limit on the porosity since an increase in porosity may lead to a decrease in tensile strength of the separator membrane. As such, in some embodiments, the separator membrane will have a porosity in the range from about 50% to about 75%; preferably, the porosity is in the range from about 55% to about 70%, or about 60% to about 70%.

Together, the porosity and vertical-alignment of the pores reduce the tortuosity and increase the ion transport properties of the separator membranes described herein. Ion transport can be measured as a MacMullin number, which is the ratio of the resistance of the electrolyte-filled separator to the resistance of the electrolyte alone. The separator membranes described herein will preferably have a MacMullin number that is less than about 9.0 in an ionic liquid; more preferably, less than about 5.0; even more preferably, the MacMullin number will be less than about 4.5, or less than about 4.0. Additionally, the separator membranes described herein will preferably have a MacMullin number that is less than about 9.0 in an organic liquid; more preferably, less than about 8.0; even more preferably, the MacMullin number will be less than about 7.0, or less than about 6.5.

To further improve wettability, it may be desirable to embed ceramic particles into the polymer matrix via infiltration as opposed to simply coating the surface of the membrane. At the same time, ceramic embedding may also improve the durability of the separator membrane. Suitable ceramics include, but are not limited to, particles of silica (e.g., SiO₂) and alumina (e.g., Al₂O₃), titanium oxide (e.g., TiO₂), ZrO₂, MgO, and garnet Li₇La₃Zr₂O₁₂ (e.g., LLZO). In some embodiments, the separator membranes disclosed herein contain a plurality of embedded ceramic particles and have a tensile strength when measured with a universal testing machine following ASTM-D882, which is standard in the art, of at least about 1 MPa, e.g., 1 MPa, 2 MPa, 3 MPa, 4 MPa, 5 MPa, 6 MPa, 7 MPa, 8 MPa, 9 MPa, or 10 MPa, or more. Preferably, the separator membranes contain a plurality of embedded ceramic particles and have a tensile strength of at least about 5 MPa; preferably, at least about 8 MPa, or at least about 9 MPa, or at least about 10 MPa.

In some embodiments, the polymeric film mixture may include ceramic particles prior to tape casting. The ceramic particles (e.g., SiO₂, Al₂O₃, etc) can be added to the mixture containing the polymer and solvent. As such, the ceramic particles are present in the mixture at a concentration from about 0.5% to about 25% by wt of the total mixture, e.g., 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25% by wt of the total mixture; preferably, the concentration is from about 0.5% by wt to about 10% by wt. Therefore, the separator membrane is said to be produced from freeze casting a polymer mixture or solution containing a concentration of ceramic particles in the range from about 0.5% to 10% by wt; preferably between about 0.75% and about 3% by wt. In other words, the identified concentration is the concentration of ceramic particles in the mixture or solution rather than the final concentration of ceramic particles in the separator membrane. For instance, in one particular embodiment, the polymer solution contains about 0.75%, 1.5%, or 2.25% by wt Al2O3; or about 8% or 16% by wt tetraethyl orthosilicate (TEOS).

The separator membranes described herein will also have improved wettability as compared to, e.g., filter paper and monolayer polypropylene membranes. In some embodiments, the separator membranes of the present invention will have contact angels of less than about 70°, e.g., 70°, 65°, 60°, 55°, 50°, 45°, 40°, 35°, 30°, 25°, 20°, 15°, 5°, 4°, 3°, or 2°, with organic or ionic electrolytes; preferably, the contact angles are less than about 60°. In other embodiments, the separator membranes will have contact angles that are less than about 50° with organic electrolytes; more preferably, they are less than about 40° or less than about 30°. For aqueous electrolytes, the separator membranes produced by the methods herein may have contact angles that are less than about 100°.

The pores discussed above can be referred to as “primary pores”. In addition to the primary pore structure, some embodiments of the separator membrane includes a hierarchical pore microstructure. As shown in FIG. 2, for example, the plurality of primary, vertically-aligned pores contain a plurality of secondary pores. While not willing to be bound by theory, it is believed that these secondary pores are due to the presence of certain organic compounds used during the sol-gel production of the separator membranes, such as, but not limited to TEOS. The hierarchical pore structures and, in particular, the presence of the secondary pores, may increase the surface area for greater liquid uptakes.

A non-limiting exemplary embodiment of desirable characteristics for a PDVF-HFP separator membrane is shown in Table 1.

TABLE 1
Separator Membrane Specifications.

| Parameter | Value | |
|---|---|---|
| Average Pore Diameter | <1 | μm |
| Porosity | >60% | |
| Membrane Thickness | 20-50 | μm |
| Liquid Uptake | >300% | |
| MacMullin Number | <4.0 | |
| Tensile Strength | 10 | MPa |
| Electrochemical Stability | >4.5 | V |
| Thermal Shrinkage at 100° C. | <1% | |
| Thermal Stability | >200° | C. |

A separator membrane as described above may be used in an ion battery, such as, but not limited to a lithium ion battery, a sodium ion battery, a magnesium battery, a calcium battery, a potassium battery, and an aluminum battery. In a particular embodiment, the separator membranes described herein are used in a sodium ion battery (e.g., Na₃V₂(PO₄)₃/NaTi₂(PO₄)₃ full cell battery), a cyclic carbonate electrolyte 1M NaClO₄ in PC/EC (1:1), an ionic liquid electrolyte 1M NaFSI in (PYR₁₃)FSI, or in a water-in-salt electrolyte 17M NaClO₄ in water. The separator membrane is disposed between the cathode and anode components of the ion battery, such that the separator membrane can selectively transfer ions from the anode compartment to the cathode compartment and vice versa depending on whether the battery is in a charged or discharged state.

### Bidirectional Freeze Casting

To create the novel and innovative vertically-aligned primary pore structure of the separator membranes, a bi-directional freeze-casting process is described herein. In general, the bidirectional freeze-casting method includes the steps of 1) solution preparation; 2) tape casting the membrane solution; 3) freeze casting; 4) solvent extraction; and 5) optional ceramic nanoparticle infiltration.

The solution preparation begins with the selection of the one or polymer compounds and a compatible solvent. Suitable polymers include, but are not limited to, polyvinylidene fluoride (PVDF), poly(vinylidene fluoride-co-hexafluoropropylene) (PVDF-HFP), polyimide, polyamic acid, polyolefin, polytetrafluoroethylene, polyvinyl chloride, polypropylene, polyethylene, polyethylene terephthalate, and polyacrylonitrile. Suitable solvents are known in the art and include solvents with low boiling points, e.g., of less than about 260° C. such as, but not limited to dimethyl sulfoxide (DMSO), dioxane, dimethyl carbonate (DMC), benzene, arachidic acid, diphenyl sulfone, and dioxolane. As the concentration of polymer is increased (and, conversely, the concentration of solvent decreased), the porosity and pore diameter of the separator membrane tend to decrease. As such, suitable starting concentrations of polymer may be about 10% by wt to about 35% mixed with solvent (e.g., about 65% by wt to about 90% by wt of DMSO or dioxane for a total of 100%). In a more preferred embodiment, the starting concentration of polymer is between about 15% by wt and about 30% by wt, or between about 15% by wt and about 25% by wt. The compatibility of the polymer selected by the skilled artisan and the suitable solvent can be determined in a 3D Hansen space according to the following Equation 1:

(Rₐ)²=4(δ_{d,p}−δ_{d,s})²+(δ_{p,p}−δ_{p,s})²+(δ_{h,p}−δ_{h,s})² Equation 1

Where d, p, and h denote the London dispersion forces, polarity, and hydrogen bonding contributions, respectively, to the total solubility parameter δₜ. The subscripts p and s denote the polymer and solvent, respectively. Further, the relative energy difference (RED) of the system can be calculated according to the following Equation 2:

$$RED = \frac{{R}_{a}}{{R}_{0}} \qquad Equation 2$$

Where R₀ is the interaction radius of the substance to be resolved. RED values of less than 1 indicate that the molecules are alike and likely to dissolve in solution, whereas RED values of greater than 1 indicate that the molecules will not dissolve in solution. A RED value of 1 indicates that the system will partially dissolve in solution.

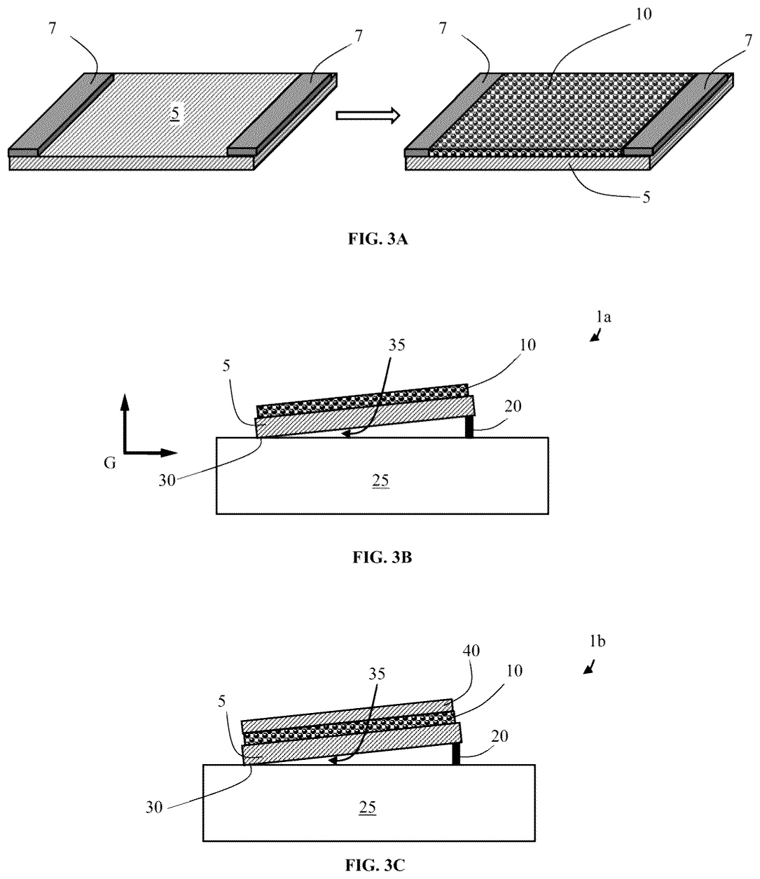

The polymer and solvent solution are heated until homogeneous, and then the solution is tape cast onto a glass or metal substrate to produce a thin film (about 1 mil to about 15 mil). Suitable substates include glass, aluminum, copper, and stainless. The substrate may be about 0.015 inches to 0.050 inches thick (preferably, between about 0.015 inches to 0.035 inches thick or between about 0.016 inches and about 0.025 inches thick) and having a length and width slightly larger than the desired separator membrane dimensions as will be readily understood by the skilled artisan (e.g., about 6 inches by 6 inches). Tape casting techniques are known in the art and include, for example, use of a hand-held doctor blade (see also, FIG. 3).

The tape-cast substrate is then subjected to bidirectional freeze casting. The bidirectional freeze-casting apparatus includes a freezing stage and a spacer element (e.g., polytetrafluoroethylene or polycarbonate). The portion of the freezing stage that contacts the substrate with tape-cast film is sometimes referred to as a “cold finger”. Further, since the freeze casting by be carried out as a one-sided freeze-casting method of a two-sided freeze-casting method as explained below, the freezing casting assembly may optionally include a pre-chilled top plate or “top cold finger”. In either method, the tape-cast substrate is placed onto the freezing stage such that one end of the substrate contacts the “cold finger” of the freezing stage while the other end rests on the spacer element. The tape-cast substrate is left in contact with the cold finger until the separator membrane is completely frozen.

The freezing stage/cold-finger is pre-chilled at a low temperature to facilitate the freeze-casting process. In some embodiments, the temperature of the freezing stage/cold-finger is between about −20° C. and about −200° C., e.g., −20° C., −30° C., −40° C., −50° C., −60° C., −70° C., −80° C., −90° C., −100° C., −110° C., −120° C., −130° C., −140° C., −150° C., −160° C., −170° C., −180° C., −190° C., or −200° C.; preferably, it is from about −35° C. to about −190° C.; more preferably, it is from about −40° C. or −50° C. to about −190° C. The freezing stage and cold finger can be made from any highly thermal conductive material, such as, but not limited to, aluminum, copper, and stainless steel. Further, the freezing stage and cold finger may be integral such that the cold finger is a portion of the freezing stage, or they can be separate components. In general, the thermal conductivity for the freezing stage/cold finger may be from about 80 W/m·K to about 300 W/m·K, e.g., 80 W/m·K, 90 W/m·K, 100 W/m·K, 110 W/m·K, 120 W/m·K, 130 W/m·K, 140 W/m·K, 150 W/m·K, 160 W/m·K, 170 W/m·K, 180 W/m·K, 190 W/m·K, 200 W/m·K, 210 W/m·K, 220 W/m·K, 230 W/m·K, 240 W/m·K, 250 W/m·K, 260 W/m·K, 270 W/m·K, 280 W/m·K, 290 W/m·K, or 300 W/m·K. In preferred embodiments, the thermal conductivity is between about 100 W/m·K and about 200 W/m·K. The freezing stage/cold finger temperature may be controlled by any suitable medium or apparatus, such as a thermoelectric cooler (TEC), liquid nitrogen, dry ice. In some embodiments, the freezing stage/cold finger is pre-chilled in dry ice or liquid nitrogen for a period of time sufficient to reach equilibrium with the dry ice or liquid nitrogen (e.g., about 30 minutes). In other embodiments, the temperature of the freezing stage/cold finger is controlled by a TEC array.

The spacer element should be between about 0.00 mm and 4 mm high, e.g., 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, or 4.4 mm high. Preferably, the spacer element should be between about 0.00 mm and 3.5 mm high and have less thermal conductance than the freezing stage/cold finger. The height of the spacer element in relation to the surface of the cold-finger creates an air wedge on the bottom surface of the tape cast substrate that is at an upward angle from the cold-finger ranging from about 0° to about 35°, e.g., 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, or 35°. In a preferred embodiment, the upward angle is between about 0° and about 30°. In one particular embodiment, the upward angle is about 28°.

As discussed above, the desired average pore diameter of the primary pores in the separator membranes is about less than 1 μm to about 10 μm; preferably, less than about 5 μm; more preferably less than about 1 μm. In addition to the average pore diameter being effected by the polymer concentration, the average pore diameter can be reduced during freeze casting according to Equation 3:

s∝(VG)^{-c} Equation 3

Where pore size s is proportional to the freezing front velocity V and the temperature gradient G. The constant c is numerically calculated to range from between about 0.25 and 0.5. Using this relationship, the average pore diameter can be reduced by the height of the air wedge (controls V as a function of temperature transport at the z-axis) and lowering the temperature of the cold finger (controls G).

The freeze-casting model is summarized in FIG. 3. The tape-casting substrate 5 is prepared for tape casting by disposing a pair of spacer tape sections 7 (e.g., Kapton tape) having a desired thickness (e.g., about 200 μm). The polymer/solvent solution 10 is then tape cast onto the tape-casting substrate 5 using, for example, a hand-held doctor blade. The tape-cast substrate 5 is then placed onto the pre-chilled freezing stage 25 of the one-sided freeze-casting assembly 1a with the leading edge in direct contact with the cold finger 30 and the opposite end placed onto the spacer element 20 to create an air wedge 35. The temperature difference between the tape-casting substrate 5 and the pre-chilled freezing stage 25 creates a temperature gradient (G) in two directions as shown in FIG. 3B.

In an alternative embodiment, a second or top cold finger is used. The top cold finger can be any thermally conductive material and can be the same material as the freezing stage and cold finger, or it can be a different material. Suitable materials for the top cold finger include aluminum, copper, and stainless steel. The top cold finger can be temperature controlled or pre-chilled at a temperature that is the same as the temperature of the freezing stage (e.g., between about −20° C. and about −200° C.; preferably, between about −35° C. and about −190° C.; more preferably, between about −40° C. or −50° C. and about −190° C.), or the top cold finger can be slightly warmer or colder than the freezing stage. Shown in FIG. 3C is an illustration of the two-sided freeze-casting assembly 1b. As shown in FIG. 3C, the top cold finger 40 is disposed on top of the tape cast substrate 5 and polymer/solvent solution 10 during the freeze-casting process to create a sandwich arrangement. Because the one-sided assembly tends to create larger pore diameters on the “hot” side of the separator membrane (side opposite the cold finger) as compared to the “cold” side, the two-sided method enables smaller pore diameters on both the “hot” and “cold” sides, albeit at the expense of the vertical pore length (see Examples for additional detail).

Once the polymer/solvent film is frozen, the tape cast substrate and film is immersed in a water bath around 4° C. for several minutes to remove the frozen solvent in the film via solvent extraction. As the solvent is removed, it leaves behind the hollow pores. The membrane is then rinsed with deionized water and ethanol and then dried at room temperature, e.g., for about 24-48 hours or more. In some embodiments, the drying step is carried out in a sub-atmospheric pressure environment to facilitate solvent removal.

### Ceramic Infiltration

In an alternative embodiment, the polymer matrix is infiltrated with silica or alumina particles to enhance wettability and tensile strength of the resulting separator membrane. This may be performed during the process as the ceramic material is added to the polymer/solvent mixture and/or by an infiltration procedure.

This alternate process begins with a suitable polymer, such as polyvinylidene fluoride (PVDF), poly(vinylidene fluoride-co-hexafluoropropylene) (PVDF-HFP), polyimide, polyamic acid, polyolefin, polytetrafluoroethylene, polyvinyl chloride, polypropylene, polyethylene, polyethylene terephthalate, and polyacrylonitrile, which is mixed with a compatible solvent (e.g., DMSO, dioxane, DMC) as discussed above. Again, suitable starting concentrations of polymer may be about 10% by wt to about 35% mixed with solvent and the ceramic or metal co-solvent solution. For example, if silica is to be embedded in the polymeric matrix, a sufficient amount of tetraethyl orthosilicate (TEOS) is added. The amount of TEOS is typically between about 5% by wt and about 20% by wt. In another example, aluminum nanoparticles are embedded into the polymeric matrix. To this end, the polymer/solvent mixture is further admixed with aluminum oxide nanoparticles (Al₂O₃) at a concentration of between about 0.5% by wt and about 5% by wt; preferably, about 0.75% by wt to about 3% by wt.

In some embodiments, dispersants or other detergents can be added to the solution to improve the separation of ceramic particles and prevent clumping. Suitable dispersants include, but are not limited to, KD1 (polyester/polyamide co-polymeric dispersant), sodium dodecyl sulfonate, sodium dodecyl benzene sulfonate, sodium hexameta phosphate, EDTA-Na, PVP, and the like.

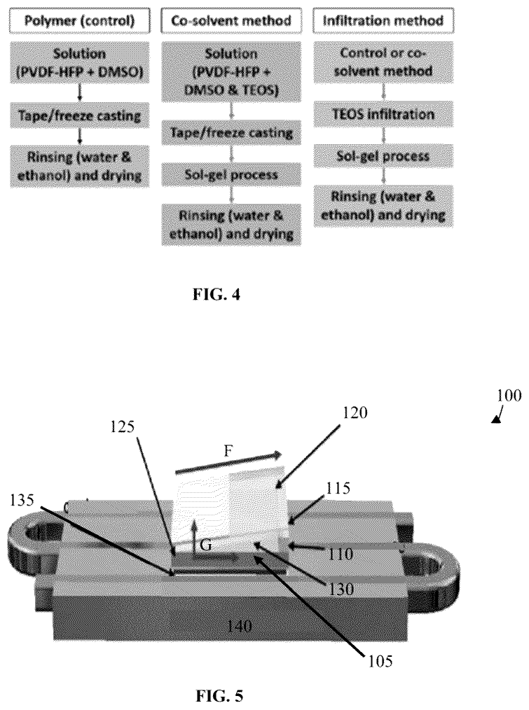

The mixture is then heated until homogeneous and then tape cast, freeze cast, and then immersed into the 4° C. water bath as described above. The membrane is then subjected to a sol-gel process for at least about 12 hours followed by another round of rinsing with deionized water and ethanol to remove residual solvent. The sol-gel process typically involves soaking the membrane in a sol-gel solution, such as, but not limited to a mixture of ethanol and ammonium hydroxide. Suitable sol-gel solutions are known in the art and will not be explained in additional detail. The membrane is then dried at room temperature for about 24 hours. Next, the membranes are soaked in a solution containing the same ceramic/nanoparticles as in the initial mixing step to facilitate particle infiltration. After nanoparticle filtration, the membrane is then again subjected to the sol-gel process, rinsed, and dried. A flow chart summarizing a non-limiting exemplary infiltration process using PVDF-HFP polymer, DMSO solvent, and TEOS cosolvent is shown in FIG. 4. The above process can be modified for laboratory-scale using dry ice, liquid nitrogen, or TEC as the cooling source.

The following examples further illustrate the present invention.

### EXAMPLE 1

### Evaluation of PVDF-HFP Membranes Fabricated Using the Bidirectional Freeze-Casting Method (−25° C. Cold Finger)

Preparation of the Al₂O₃-PVDF-HFP and SiO₂-PVDF-HFP Separator Membranes

In order to evaluate the functional characteristics of the separator membranes discussed above, a novel and innovative bidirectional tape-freeze casting process was used to produce PVDF-HFP separator membranes for analysis. The tape-freeze casting assembly used for this study is shown in FIG. 5. As shown in FIG. 5, the tape-freeze casting assembly 100 includes an aluminum freezing stage 105 and a TEFLON spacer element 110. In this process, the tape-cast substrate 115 is a glass slide onto which the polymer/solvent film 120 is tape cast. The glass substrate 115 is placed onto the aluminum freezing stage 105 so that the edge of the glass substrate 115 contacts the cold finger 125 of the freezing stage 105. The presence of the TEFLON spacer element 110 provides for an air wedge 130 between the bottom surface of the glass substate 115 and the aluminum freezing stage 105. The temperature gradient G is shown, as is the direction of the freezing front F. In this study, the cooling temperature was controlled via thermoelectric cooler (TEC) 135 that also includes a heat reservoir 140.

A series separator membrane samples (PVDF, PVDF-HFP, Al₂O₃-filled PVDF-HFP composite membranes) were prepared. Briefly, suspensions consisting of different alumina contents (1.22 wt %, 1.73 wt %, 2.58 wt %, and 3.41 wt % with respect to the solvent dioxane), with or without the dispersant (KD1, of the same weight as added Al₂O₃) and dioxane were produced through ball milling for 24 h. The suspensions were then removed from the ball mill containers and different amounts of PVDF-HFP were added to the suspensions in order to obtain a concentration of 15 wt % PVDF-HFP with respect to dioxane and alumina contents. The alumina suspension and PVDF-HFP mixture was heated in a vial in a water bath at 70° C. until all of the PVDF-HFP was dissolved and a stable polymer-solvent-alumina suspension was formed. The suspension was then removed from the water bath to reach ambient temperature before tape/freeze casting. Approximately 3 to 4 mL of suspension was tape cast onto a microscope glass slide (50×75 mm²) with a clearance of 200 μm. After a thin film was tape cast onto the glass slide, one end of the glass slide was quickly placed in contact with an aluminum cold finger at −25° C. on top of the TEC and aluminum freezing stage, while the other end was placed in contact with a Teflon spacer on top of the same aluminum freezing stage, which created an air wedge right below the glass slide (see FIG. 5). Once the tape-cast film was completely frozen, the glass slide with the frozen film was placed into a freeze dryer set at −40° C. and sub-atmospheric pressure for 48 h to remove dioxane in the film. After complete removal of dioxane, the porous alumina-modified PVDF-HFP membrane was removed from the glass slide with a pair of tweezers.

In addition and for comparison to the Al₂O₃-filled membranes, SiO₂ coating was added to PVDF-HFP composite membranes. Briefly, a mixture of 15 wt % PVDF-HFP and 85 wt % dioxane was heated in a vial in a water bath at 70° C. until a clear and homogeneous solution was formed. The polymer-solvent solution was then removed from the water bath to reach ambient temperature before tape/freeze casting. Approximately 3 to 4 mL of suspension was tape cast onto a microscope glass slide (50×75 mm²) with a clearance of 200 μm. After a polymer/solvent film was tape-cast onto the glass slide, one end of the glass slide was quickly placed in contact with an aluminum cold finger at −25° C. on top of a thermal electric setup, while the other end was placed in contact with a Teflon spacer on top of the same aluminum cold finger (see FIG. 5). Once the tape-cast polymer/solvent film was completely frozen, the glass slide with the frozen film was placed into a freeze dryer set at −40° C. and 400 μbar for 48 h to remove dioxane in the film. After complete removal of dioxane, the porous PVDF-HFP membrane was removed from the glass slide with a pair of tweezers. The porous PVDF-HFP membrane was then immersed in tetraethoxysilane (TEOS) under vacuum for 15 min to allow TEOS to flow into the pores. Afterwards, the TEOS-infiltrated membrane was immersed in a solution of ethanol and ammonium hydroxide (C₂H₅OH/NH₃·H₂O=20/1, vol/vol) at room temperature (RT) for the sol-gel process of TEOS to take place. After 12 h, the membrane was taken out of the solution and rinsed with deionized water and ethanol, and then dried at RT for at least 24 h.

### Morphology & Microstructure

The prepared membranes were sectioned in a liquid nitrogen bath (below the glass transition temperature of PVDF-HFP) with a pre-chilled razor blade in order to avoid artifacts due to cutting of the soft membranes at ambient temperature. The membranes were then coated with Pt/Pd before the cross-section and surface morphologies were examined using scanning electron microscopy (SEM). The distribution of alumina additions or silica formed by the sol-gel process of TEOS was examined using the energy-dispersive X-ray spectroscopy (EDS).

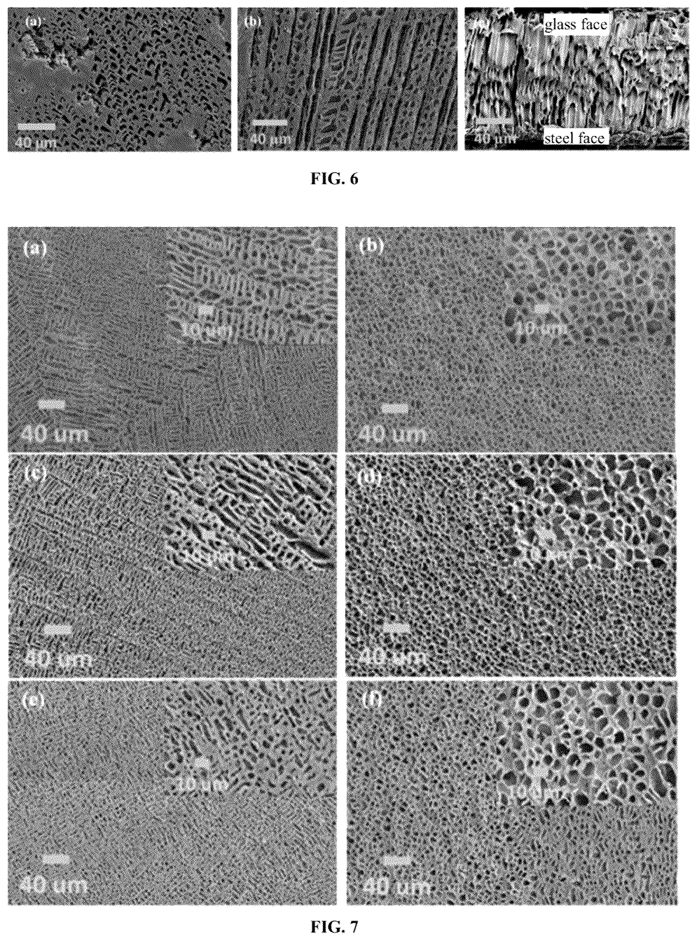

FIG. 6 shows the surfaces (glass face and steel face, also can be referred to as the hot face and cold face, respectively) and cross-section images of a PVDF membrane made by the tri-layer mold method. It clearly shows the directionally pore structures over the surfaces and the trough-thickness direction.

The bidirectional freeze-casting process noticeably improved the membrane quality. FIG. 7 shows a series of surface SEM images of three types of membranes (PVDF-HFP, 1.05% and 1.5% Al₂O₃-filled PVDF-HFP) made by the enhanced tape-freeze casting process. In FIG. 7A, pore domains at the cold face of the PVDF-HFP membrane are visible, where nucleation of dioxane crystals begin. These are subsequently removed to give rise to pore domains. In FIG. 7B, arrays of pores can be seen at the hot face of PVDF-HFP membrane. These pores are the result of dioxane crystal growth in the membrane thickness direction. The freeze-casting setup, in which the inserted TEFLON spacer induces a thermal gradient along the length of the glass slide, guides the direction of nucleation and growth of the dioxane crystals. Similar microstructures can also be seen in the case of alumina-KD1-modified membranes, as shown in FIG. 7C-7F, which implies that the amount of alumina and dispersant added does not have a significant effect on the nucleation and crystallization kinetics.

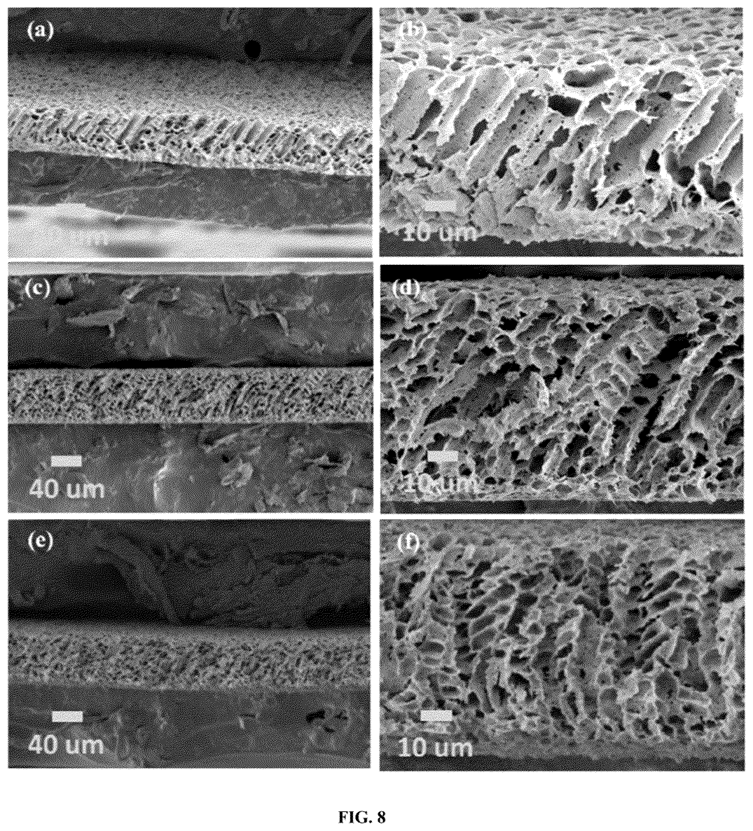

FIG. 8 shows the cross-sectional SEM images of the three membranes. In FIG. 8A, through-thickness, directionally aligned pores can be seen throughout the cross section of the PVDF-HFP membrane. At the higher magnification seen in FIG. 8B, the pore diameter of these aligned pores is determined to be approximately 5-10 μm. The directionality of the pores in the PVDF-HFP membrane is largely determined by the thermal gradient across the membrane thickness. The thickness of the porous PVDF-HFP membrane falls in the range of 60 to 70 μm. In both though-thickness views shown in FIGS. 8C and 8E, directionally aligned pores can also be observed in the alumina-KD1-modified membranes. At the higher magnification shown in FIGS. 8D and 8F, the pore diameters of 1-5 μm appear to be slightly smaller than those from the KD1-free membrane in FIG. 8B. It is worth noting that the pore size is slightly larger than the pore size goal (<1 μm), although no cell shorting occurred due to the electrode particle crossover in coin cell assessment described later.

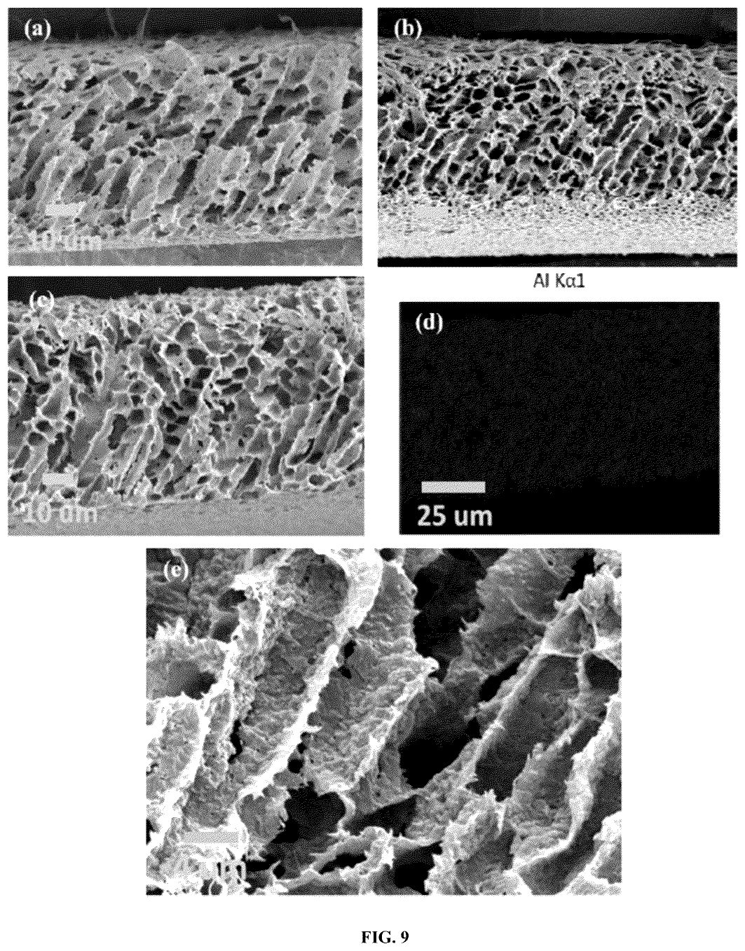

Al₂O₃ nanoparticles were introduced into the polymer membranes in order to improve the wettability and thermal stability. However, the difficult challenge of creating a separator membrane with a uniform dispersion of the nanoparticles needed to be overcome. In the one particular embodiment, this problem was solved through longer time ball-milling and using the dispersant (KD1). However, and as explained in Example 3, the modified infiltration method also solved this issue. FIG. 9 shows cross-sectional SEM images of three types of membranes, 1.05 wt %-alumina-modified, 1.5 wt %-alumina-modified, and 2.25 wt %-alumina-modified membranes. In all three modified membranes, cross-sectional imaging revealed directionally aligned pores with some visible secondary pores/side arms observed. There was no distinct difference in microstructure between membranes made with different alumina contents, which implied that the amount of alumina added did not drastically alter the nucleation and crystallization kinetics. In FIG. 9D, the Al signal of EDS mapping indicates that the distribution of alumina was uniform across the membrane thickness. Furthermore, higher magnification revealed numerous well-dispersed, spherical alumina particles were dispersed across the cross-section without any discernible alumina agglomerates (see FIG. 9E).

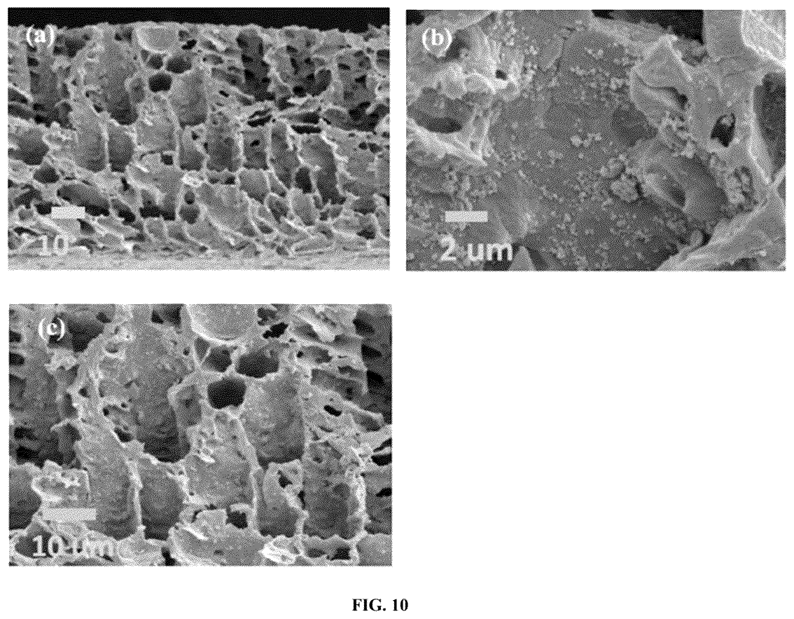

The SiO₂ nanoparticles were also observed to be uniformly dispersed on the surface of SiO₂-coated samples. FIG. 10 shows cross-sectional SEM images of the silica-modified membranes. In FIG. 10A, vertically aligned pores with some visible secondary pores/side arms were observed throughout the cross-section. In addition, neither the infiltration of TEOS nor the subsequent sol-gel process altered the cross-sectional microstructure. At higher magnification, as shown in FIG. 10B, nano-sized silica particles derived from the sol-gel process of TEOS were clearly visible. As shown in FIG. 10C, the distribution of silica was uniform across the cross-section. The Si and O signals (specs) from EDS mapping also showed that the distribution of silica was uniform across the membrane thickness (data not shown). The amount of silica introduced into the PVDF-HFP membrane was estimated to be from 8 to 17 wt % of the composite solid by measuring the weight change before and after the treatment.

Membrane porosity, ε, the pore volume relative to the total volume of the membrane, can be determined by the gravimetric method, here performed with ethanol according to Equation 4:

$$ε = \frac{\frac{{W}_{w} - {W}_{d}}{{ρ}_{e}}}{\frac{{W}_{w} - {W}_{d}}{{ρ}_{e}} + \frac{{W}_{d}}{{ρ}_{p}}} \qquad Equation 4$$

where Ww and Wd are the weights of wet and dry membrane, and ρₑ and ρₚ are the densities of the ethanol and polymer. Membranes were soaked in ethanol for 24 h before measuring the wet membrane weight. Each membrane was measured five times.

Porosities of PVDF-HFP and ceramic-modified membranes are reported in FIG. 11 with Celgard 2500 as a reference. In the case of Celgard 2500, the measured porosity was 54%, consistent with the value given in the manufacturer's data sheet (55%). The expected porosity of a 15 wt % PVDF-HFP membrane, based upon weight fractions of raw materials is 90.7%, which aligned with the measured porosity of 86.7%. The measured porosities of the ceramic-modified membranes ranged from 86 to 89% which were quite close to the PVDF-HFP membrane, since the amount of added ceramic was small.

### Wettability

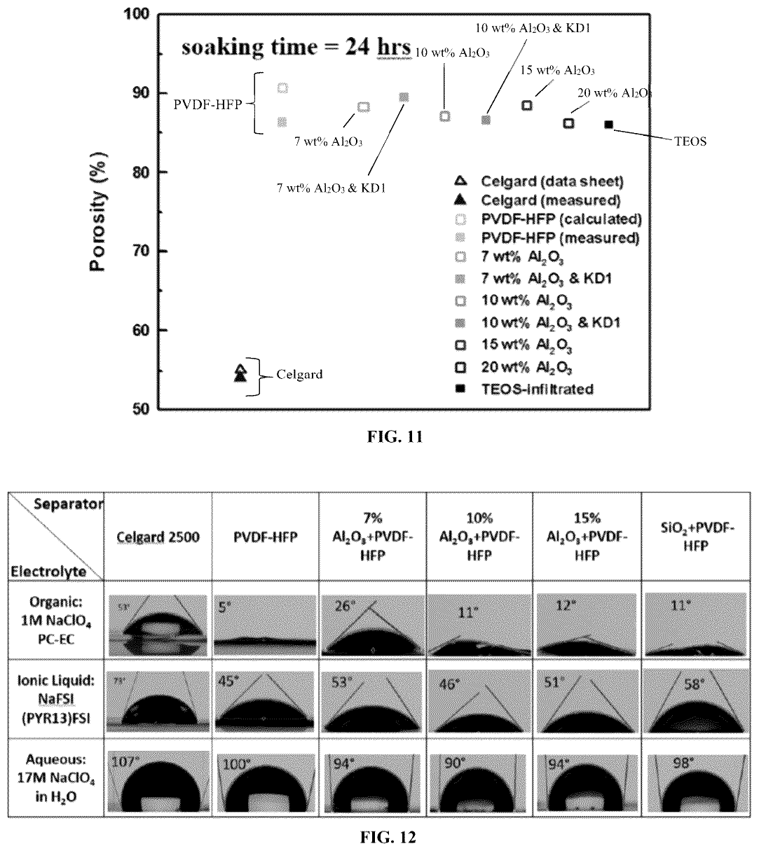

The wettability of the separators in three electrolytes (organic carbonate 1M NaClO₄ in PC/EC, ionic liquid NaFSI/(PYR13)FSI (1:9), and water-in-salt 17M NaClO₄ in H₂O electrolytes) was evaluated in terms of contact angle and electrolyte uptake. Contact angles were measured by a computer-controlled Ossila Goniometer. The droplets were applied using 10 μl from a syringe. The contact angle was defined as the angle between a droplet and the surface of the separators at the 5th second after the droplet reached the surface of the separators. FIG. 12 shows the contact angle results of different separators in three electrolytes for sodium ion batteries. It was shown that Celgard 2500 had high contact angels in all of the electrolytes, including the organic carbonate electrolyte (indeed, most studies of sodium ion batteries use filter paper as separator rather than Celgard). The freeze-cast PVDF-HFP and composite separator membranes showed much lower contact angles than Celgard 2500.

### Electrolyte Uptake

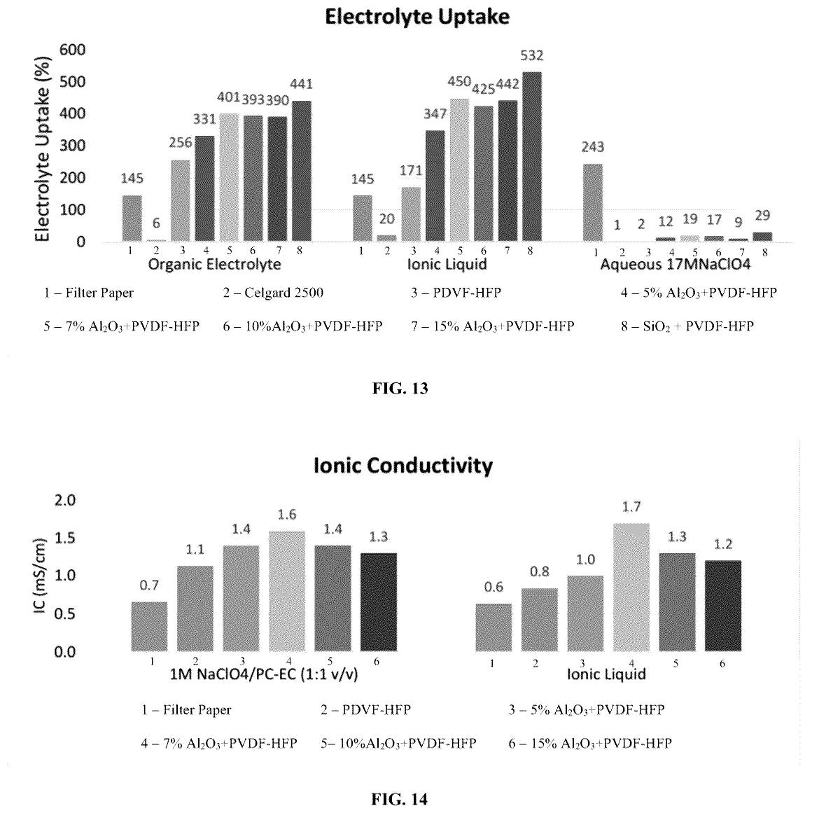

Electrolyte uptake was conducted by the following procedure: a small piece of separator material (5-8 mg) was soaked in electrolyte solution (about 0.5 g) for 4 hours. The weight of the separator was recorded after excess electrolyte on the surface was wiped away using tissue paper. The weight before and after soaked was the amount of electrolyte uptake. The percentage of electrolyte uptake was calculated by dividing the amount of electrolyte uptake by the weight of the dry separator before soaking. FIG. 13 shows the electrolyte uptakes of different separators in three electrolytes. The data confirmed again the poor of wettability of Celgard's polyolefin separator for SIB electrolytes. We thus excluded Celgard 2500 for further assessment in coin cells. The filter paper separator had modest wettability in all three electrolytes; whereas the freeze-cast separator membranes showed excellent uptake in organic and ionic liquid electrolytes. The Al₂O₃ filling at various ratios and the SiO₂ coating significantly improved the electrolyte uptake. The uptakes (up to 400-500%) completely met the targeted 300%.

### Ionic Conductivity & Permeability

Ionic conductivity was measured by Electrochemical Impedance Spectroscopy in a Solartron 1287 potentiostat and 1260 FRA. The separator, soaked with 50 μl of electrolyte, was placed between two stainless steel spacers and sealed in CR2032 coin cells. The ionic conductivity was calculated according to equation 5:

Ionic conductivity (mS/cm)=L/(Z×A) Equation 5

where L is the ion transfer path or length or gap in the media between two conductors (stainless steel), such as separator thickness; A is the cross-sectional area, and Z is the measured resistance. The permeability of separators was assessed from the MacMullin number, which is defined as the ratio of ionic conductivity without and with separators. The ionic conductivity of electrolytes without separators was measured using a coin cell where a PTFE O-ring was designed and placed between two stainless steel spacers to hold the electrolyte in the void.

FIGS. 14 and 15 show the ionic conductivity and MacMullin numbers, respectively, of different separators in both organic carbonate and ionic liquid electrolytes. The results show the freeze-cast PVDF-HFP separator had greater ionic conductivity than filter paper, and the ceramic-filled PVDF-HFP further increased the ionic conductivity. Compared to filter paper, freeze-cast membranes had significantly lower MacMullin numbers, indicating the benefit of lower tortuosity and higher permeability owing to the vertically aligned pore structures.

### Thermal Stability

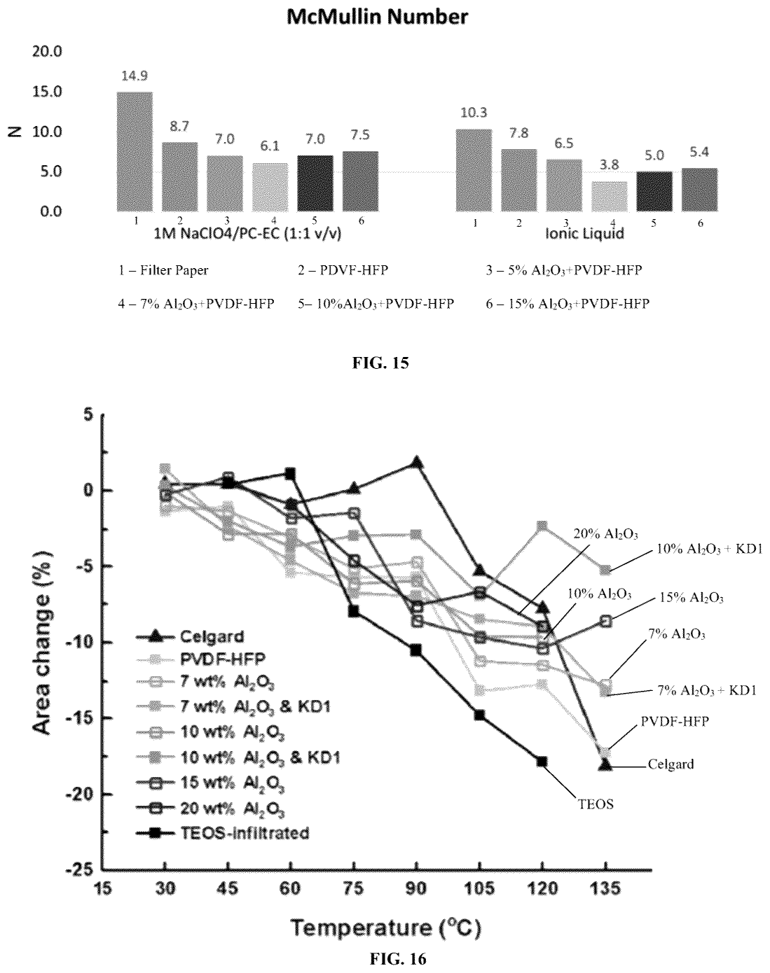

Thermal stability of PVDF-HFP and ceramic-modified membranes was assessed by the area change after heat treatment and are reported in FIG. 16 with Celgard 2500 as a reference. The general trend of all membranes showed that the area change increased with treatment temperature. The addition of alumina improved the thermal stability slightly in comparison with pure PVDF-HFP membranes, especially in the high temperature range. However, the introduction of silica exacerbated area change, particularly above 75° C. While not intending to be bound by theory, this was likely due to the fact that silica particles were coated on the pore walls instead of being embedded inside the pore walls.

### Mechanical Strength

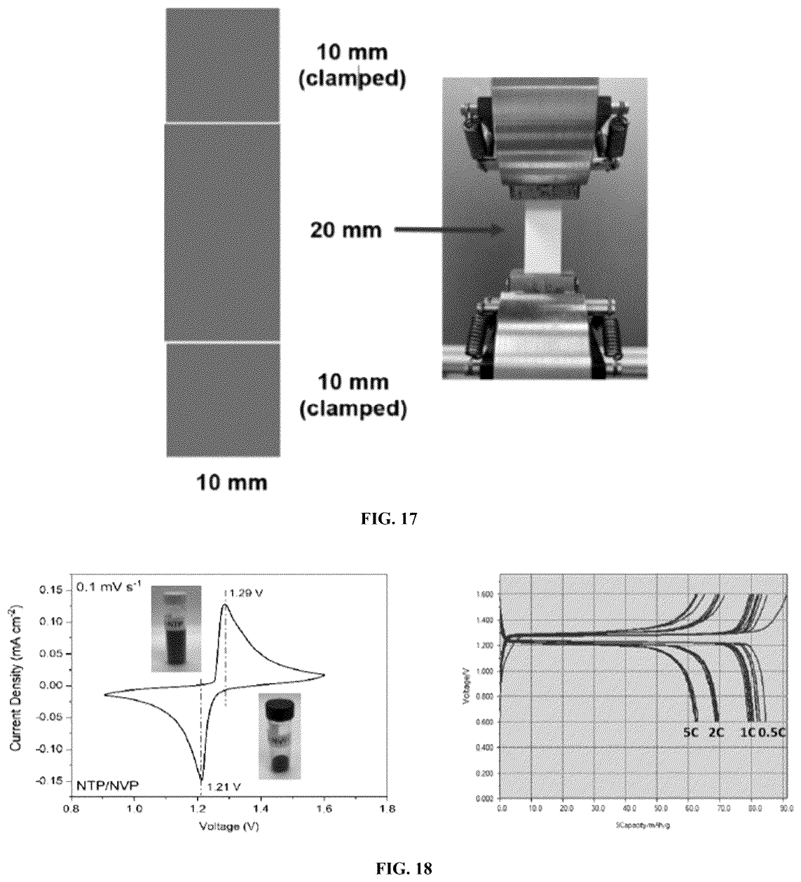

Tensile strengths of membranes were determined by conducting tensile tests with a universal testing machine (Instron 5982) following ASTM-D882. Membranes were cut into strips 40×10 mm2. While testing, 10-mm lengths of strips were clamped with grips, as illustrated in FIG. 17. The strain rate was set at 0.1 min-1, which was equivalent to a displacement rate of 2 mm min⁻¹. The selected load cell was 500 N.

The results showed that the PVDF-HFP membranes had a lower tensile strength as compared to both filter papers and Celgard membranes. While not wishing to be bound by theory, it is possible that one of two things was occurring: first, PVDF-HFP membranes have much higher porosity compared with Whatman filter papers and Celgard membranes (strength is known to decrease with increasing porosity); and second, the tensile stress direction was perpendicular to the pore alignment, which was the weaker direction compared to the direction along the pore alignment, that is, across the membrane thickness. Also, on average, the PVDF-HFP membranes appeared to exhibit larger strains-to-failure, indicative of their enhanced compliance. The study revealed that the tensile strengths of ceramic-modified membranes were approximately 25% to 30% higher than that of pure PVDF-HFP membranes, attributed to the reinforcement by ceramic fillers (alumina or silica) of the separator membrane (data not shown). It was also found that the presence of KD1 dispersant did not have a significant effect on the tensile strength. The maximum value recorded of all separators was approximately 1.8 MPa, which exceeded certain values in a PVDF-HFP-modified ceramic-matrix system reported in the literature [Raja et al., “Thin, flexible and thermally stable ceramic membranes as separator for lithium-ion batteries” J. Membrane Sci. 471:103-109 (2014)].

### EXAMPLE 2

### Electrochemical Evaluation of PVDF-HFP Membranes in Sodium Ion Batteries

Separator membranes produced according to the procedures described in Example 1 were further evaluated in sodium ion batteries (SIBs). A Na₃V₂(PO₄)₃/NaTi₂(PO₄)₃ full cell (NVP/NTP) was selected as the assessment model cell of SIBs for the separators membranes because this SIB chemistry was known in the art as the most stable cathode/anode couple among all the SIB electrodes. This SIB couple would eliminate the concerns of solid-electrolyte interphase (SEI) formation and electrolyte oxidization and provide a more reliable comparison of separators.

The Na₃V₂(PO₄)₃ and NaTi₂(PO₄)₃ electrode materials were home-made by solid-state sintering. The cathode and anode electrodes were prepared by a traditional doctor-blade casting process with a ratio of active material/carbon black/binder of 85:10:5. The NTP anode capacity is designed 10% over the counterpart NVP cathode capacity, so that the cell capacity is limited by NVP cathode. CR2032 coin cells were used to assess the charge-discharge performance. FIG. 18 shows the baseline performance of the NVP/NTP full cell using a filter paper separator in organic carbonate 1M NaClO₄ in PC/EC electrolyte. It shows that the full cell had 84 mAh/g capacity at 0.5 C with a good capacity retention of 73% at 5 C. The baseline performance was confirmed by multiple coin cells before the cells were used to assess the separators.

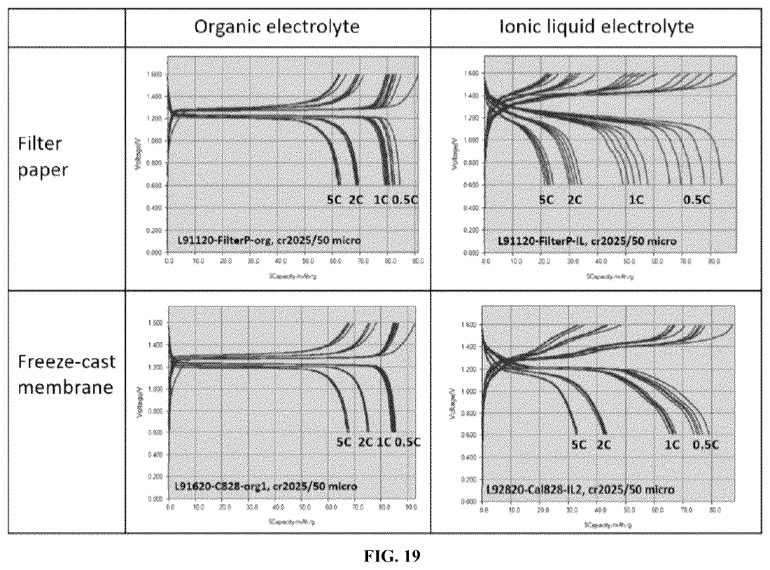

FIG. 19 compares the charge-discharge curves and rate performance of coin cells using filter paper and freeze-cast PVDF-HFP separators in both organic and ionic liquid electrolytes. In the organic carbonate electrolyte, the freeze-cast separator showed much better rate performance and cycling stability (capacity degradation per each cycle at the same rate) than filter paper. When the current was changed from 0.5 C to 5 C, the PVDF-HFP cell had a capacity retention of 81% as compared to 72% for filter paper under the same conditions. In the ionic liquid electrolyte, the cell with filter paper did not maintain stable cycling with rapid degradation every cycle, likely because of the reaction between the filter paper and the ionic liquid; while the freeze-cast separator significantly improved the rate performance and cycling stability.

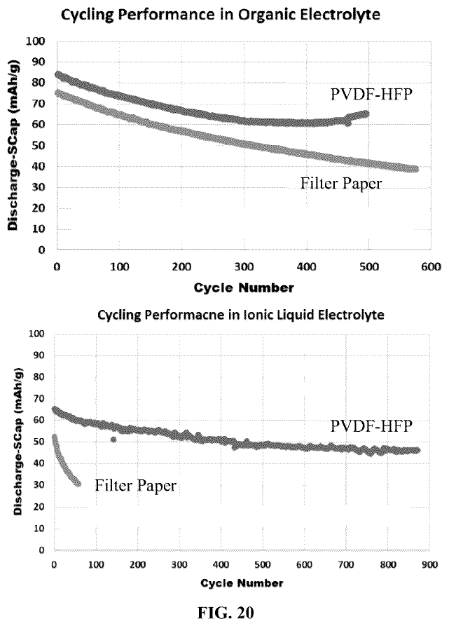

FIG. 20 shows the cycling performance of NVP/NTP coin cells with two separators (freeze-cast PVDF-HFP and filter paper) in organic and ionic liquid electrolytes. The test was conducted at 1 C between 0.6 to 1.6V. For the organic electrolyte, the capacity degradation of filter paper cell was slightly faster than PVDF-HFP cell at the first 300 cycles. After that, the PVDF-HFP cell stabilized and delivered a much better capacity retention than the filter paper cell in 500 cycles. For the ionic liquid electrolyte, the filter paper cell lost capacity very fast; while the PVDF-HFP cell delivered a much better capacity retention (remaining 75% in 870 cycles). The results clearly validated that freeze-cast PVDF-HFP separator exhibited superior functionality than the filter paper separator in SIBs with both organic and ionic liquid electrolytes.

### The Effect of Ceramic Filler on Separator Performance

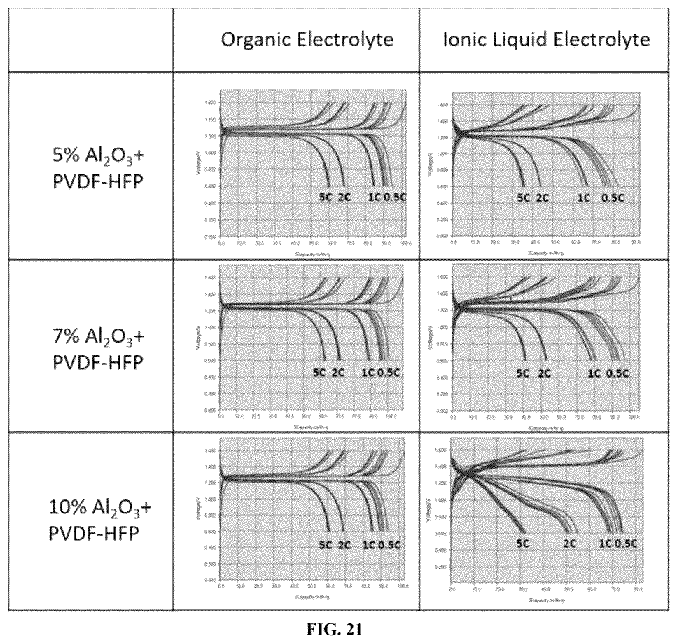

The effect of Al₂O₃ nanoparticles embedded in the PVDF-HFP separators on cell performance was also evaluated in the NVP/NTP full cells. FIG. 21 compares the charge-discharge curves and rate performance of coin cells using 0.75%, 1.05% and 1.5% Al₂O₃-filled PVDF-HFP separators in both organic and ionic liquid electrolytes. In the ionic liquid electrolyte, the composite separators delivered lower polarization, higher rate performance, and better cycling stability than the pure PVDF-HFP separator, which is consistent with the wettability and permeability results. The best cell performance was shown by the cell using the 1.05% Al₂O₃-filled PVDF-HFP separator. The result demonstrated the positive effect of introducing Al₂O₃ nanoparticles into the separator. For the organic carbonate electrolyte, the composite separators delivered higher initial capacities, but did not show improvement on rate performance over the PVDF-HFP separator.

In general, based on the electrochemical evaluation results, the freeze-cast separators were notably compatible with both organic electrolyte and ionic liquid electrolyte, enabling a better choice than filter paper as separators for sodium ion batteries.

### EXAMPLE 3

### Evaluation of PVDF-HFP and Silica-Filled PDVF-HFP Membranes Produced by the Bidirectional Freeze-Casting Method (Cold Finger Pre-Chilled with LN₂)

The bidirectional freeze-casting method was slightly modified from Example 1 to include a cold finger with a much lower temperature since to reduce the pore size according to Equation 2. In order to determine the effect of polymer concentration on the mechanical strength of freeze-cast separator membranes using the modified process, mixtures of 15, 20, 25 wt % PVDF-HFP with 85, 80, 75 wt % DMSO, respectively, were first heated in vials in an oil bath at 70° C. until clear and homogeneous solutions were obtained. Approximately 3 to 4 mL of each PVDF-HFP/DMSO solution was tape cast onto an aluminum substrate (150×150×1 mm³) at room temperature with a tape-cast thickness of 200 μm. After a polymer film was formed on the substrate, it was quickly placed in contact with an aluminum stage (150×150×50 mm³) pre-chilled with liquid nitrogen (LN2). Once the tape-cast polymer film was completely frozen, the aluminum substrate with the frozen film was immersed in a water bath at 4° C. for several minutes to remove the frozen DMSO in the film via solvent extraction. After complete removal of DMSO, the wet, porous PVDF-HFP membrane was removed from the water bath. The membrane was then rinsed with deionized water and ethanol and dried at RT for at least 24 h.

### Co-Solvent Process

To prepare the silica-infiltrated membranes, mixtures of 20 wt % PVDF-HFP with 72 wt % and 64 wt % DMSO were heated in vials in an oil bath at 70° C. until clear and homogeneous solutions were formed. Respective amounts of TEOS, 8 wt % and 16 wt %, were then added to the above solutions with 72 wt % and 64 wt % DMSO and mixed under constant stirring and heating until clear and homogeneous solutions were again formed. The steps including tape casting, freeze casting, and solvent extraction, were identical to that described above until the removal of the porous membrane from the water bath. The membrane was then soaked in a sol-gel bath consisting of a mixture of ethanol and ammonium hydroxide (20/1, vol/vol) to allow the sol-gel process to take place for at least 12 hours. This was followed by rinsing with deionized water and ethanol to remove any residual solvent and drying at room temperature for at least 24 hours. For simplicity, the composite membranes made with DMSO/TEOS ratios of 72/8 and 64/16 are denoted as D72T8 and D64T16, respectively, while the control membrane made without TEOS is denoted as D80T0.

### Infiltration Process

Next, the D80T0 and D72T8 membranes were soaked for 15 minutes in a TEOS bath to allow infiltration of TEOS into the membranes, followed by soaking in a sol-gel bath as described in the above section. The D80T0 and D72T8 membranes that underwent the infiltration process are denoted as D80T0(inf) and D72T8(inf), respectively. Shown in FIG. 3 are process flow charts for fabrication of PVDF-HFP membranes with DMSO, PVDF-HFP/SiO₂ composite membranes via the co-solvent method, and the infiltration method.

### Evaluation

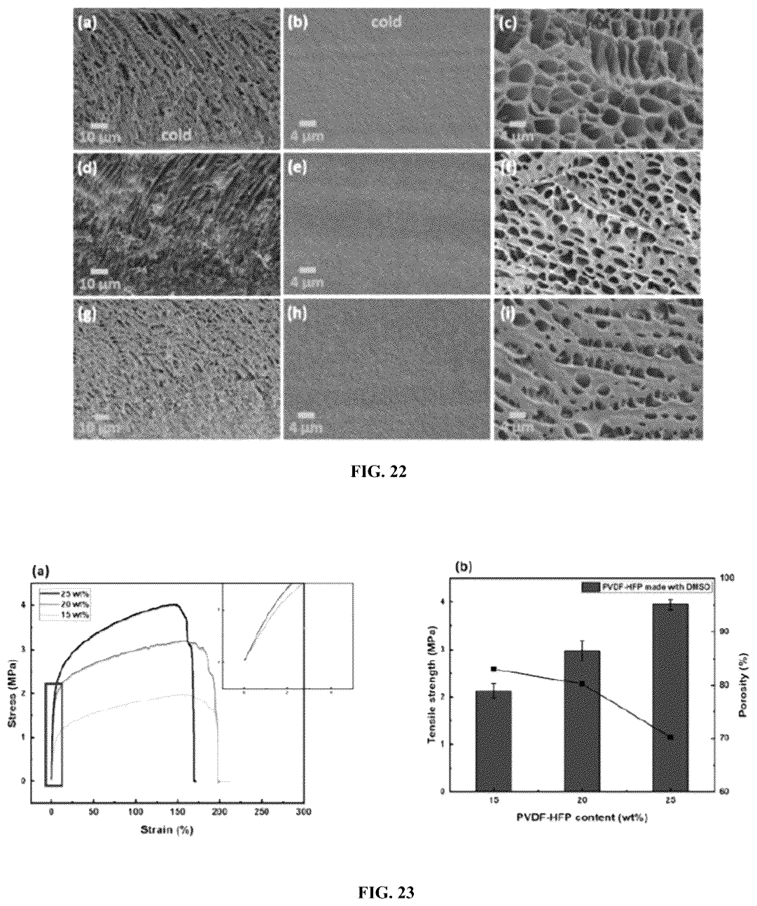

A series of SEM micrographs of PVDF-HFP membranes made with 15% wt %, 20% wt %, and 25 wt % PVDF-HFP in DMSO are shown in FIG. 22. From the cross-sectional images (FIGS. 22A, 22D, and 22G), pores with high degree of directionality were seen in all three membranes, which was a direct result of the thermal gradient imposed in the thickness direction of the membranes (see FIG. 22A). Further, the pore size increased from the cold face (bottom) to the hot face (top), which was attributed to the higher cooling rate on the cold face as compared to the hot face. This was consistent with the micrographs of the cold face (FIGS. 22B, 22E, and 22H) showing sub-micron pores and the hot face (FIGS. 22C, 22F, and 22I) showing pore size in the range of few microns. Moreover, the pore size exhibited a decreasing trend as the polymer concentration increased, especially from the perspective of cross-sections (FIGS. 22A, 22D, and 22G) and hot faces (FIGS. 22C, 22F, and 22I). The reduced pore size with increasing polymer concentration was largely due to lower solvent content and higher viscosity of the solution which hindered diffusion of solvent and polymer molecules during freezing. What's more, from the hot face, it was found that the porosity decreased with increasing polymer concentration, since the solvent content also lowered with increasing polymer concentration.

FIG. 23A displays representative stress-strain curves of PVDF-HFP membranes. It was clear that the tensile strength of the membranes increased with increasing polymer concentration. In addition, in the initial region of the curves marked by the rectangle and shown as the insert, the stiffness of membranes increased as the polymer concentration increased. In FIG. 23B, tensile strength increased with increasing polymer concentration, while an opposite trend in membrane porosity was observed, which was in agreement with the micrographs in FIG. 22. While not intending to be bound by theory, it is believed that the strength of porous material is inversely proportional to the material porosity. Therefore, decreasing porosity by increasing the polymer concentration was found to be an effective way to strengthen the membranes. However, an increase in polymer concentration is usually accompanied with increase in solution viscosity, which makes processing more difficult.

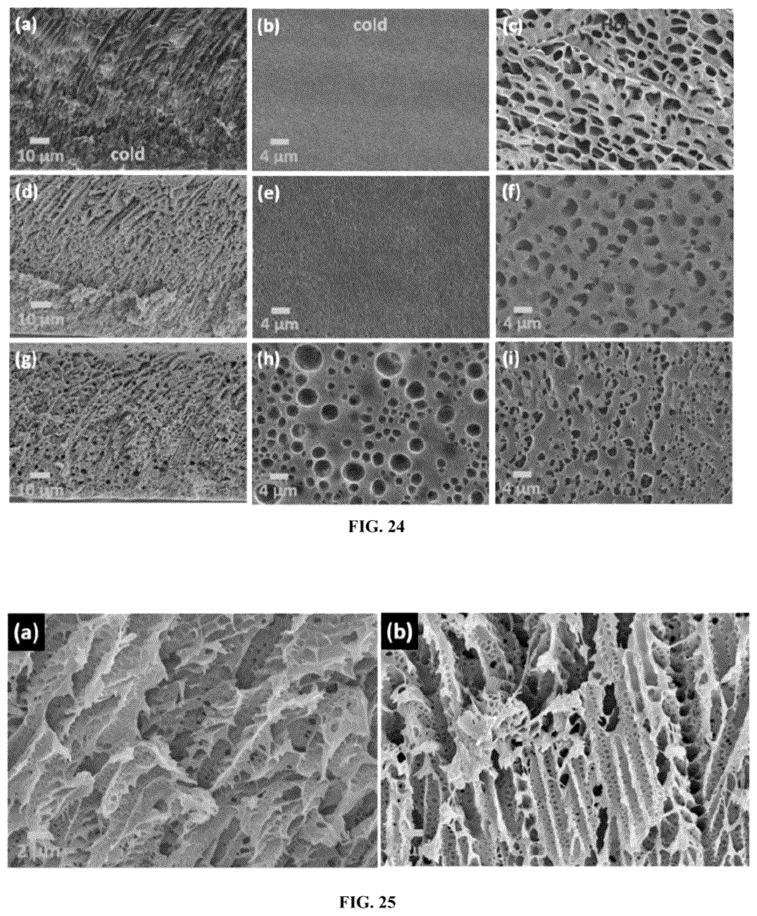

Next, the separator membranes embedded with silica were evaluated. A series of SEM micrographs of PVDF-HFP membrane and PVDF-HFP/SiO₂ composite membranes made for DMSO/TEOS ratios including 80/0, 72/8 and 64/16 via the co-solvent method (see FIG. 4) are summarized in FIG. 24. From the cross-sectional images (FIGS. 24A, 24D, and 24G), directional and through-thickness pores were observed in all three membranes. When the three membranes were compared, large spherical pores were seen close to the cold face (bottom) and on the cold face of D64T16 (FIGS. 24G and 24H), whereas only sub-micron pores were observed on the cold face of D80T0 (FIG. 24B) and D72T8 (FIG. 24E). These spherical pores were present due to the fact that liquid-liquid demixing not only preceded the freezing of solvent but also took place during the tape casting process at room temperature, which allowed the polymer-lean phase (solvent-rich phase) from the liquid-liquid demixing to grow in size. From the hot faces (FIGS. 24C, 24F, and 24I), a decreasing trend in pore size was found with increasing TEOS content in the co-solvent. A likely reason is that the effective polymer concentration increased with increasing TEOS content in the co-solvent since TEOS is considered a non-solvent for PVDF-HFP.

At a higher magnification of the cross-section of D72T8 membrane (FIG. 25A), a hierarchical pore structure with small spherical pores aligned on the directional pore walls was observed. In order to understand the origin of the hierarchical pore structure, a control membrane of D72T8 was fabricated without the sol-gel process of TEOS. The same hierarchical pore structure was again observed as shown in FIG. 25B. Based on these observations, the hierarchical pore structure is believed to result from the presence of TEOS in the co-solvent. Further, EDS Si mapping results revealed that the distribution of Si was quite uniform without any noticeable segregation suggesting that the silica particles were incorporated into the PVDF-HFP membranes via the co-solvent process (data not shown).

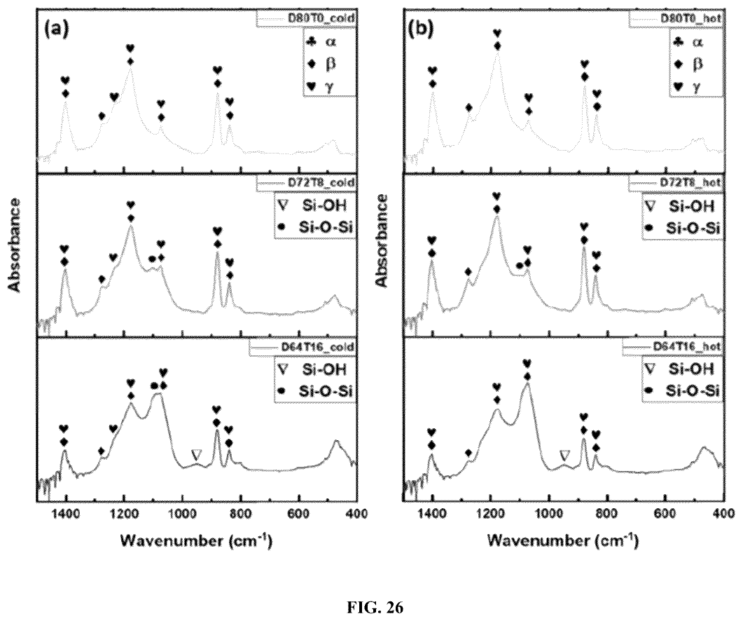

Fourier transform infrared (FTIR) spectra of the D80T0 membrane and the D72T8 and D64T16 membranes fabricated via the co-solvent method were plotted in FIG. 26. In the case of D80T0 (FIGS. 26A and 26B, top), the four characteristic peaks of the PVDF segment were found on both faces of the membrane around 881, 1071, 1176 and 1401 cm⁻¹. Since the peaks exclusively related to the α phase of PVDF around 614 and 763 cm⁻¹ were absent, the four characteristic peaks of PVDF were thus associated with the ß and γ phase of PVDF. The peak around 840 cm⁻¹ was also from the β and γ phase. Upon closer examination, an additional peak around 1234 cm⁻¹ related to the γ phase was observed only on the cold face. The appearance of this additional peak was thought to be caused by the higher cooling rate on the cold face as compared to the hot face. As the TEOS content increased in the co-solvent, additional silica-related peaks started to appear. In the case of D72T8 (FIGS. 26A and 26B, middle), apart from the characteristic peaks caused by the PVDF segment, an extra peak associated with the Si—O—Si bond around 1100 cm⁻¹ was found on both faces of the membrane. In the case of D64T16 (FIGS. 26A and 26B, bottom), an additional peak associated with the silane (Si—OH) bond around 950 cm⁻¹ was observed on both faces of the membrane. The existence of additional peaks from the Si—O—Si and Si—OH bonds were direct results of the incorporation of silica particles into the PVDF-HFP membranes, which was consistent with the EDS mapping results.

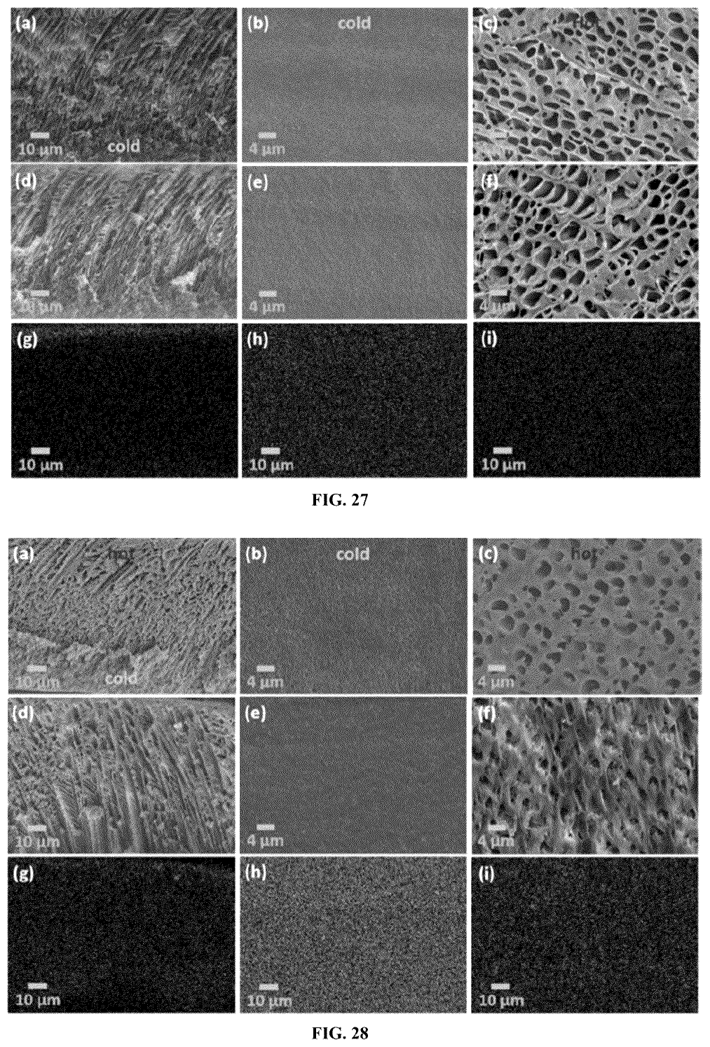

A series of SEM micrographs of D80T0 and D80T0(inf) membranes and the EDS Si mapping results of D80T0(inf) membrane were summarized in FIG. 27. When the D80T0 and D80T0(inf) membranes from the cross-section (FIGS. 27A and 27D), cold face (FIGS. 27B and 27E) and hot face (FIGS. 27C and 27F) were compared, there was no significant change in microstructure after the infiltration of TEOS. Directional and through-thickness pores were observed in both membranes from the cross-sections. Sub-micron pores were found on the cold faces of both membranes, but many of the pores on the hot faces averaged a few micrometers in diameter. From the EDS Si mapping results of the D80T0(inf) shown in FIGS. 27G, 27H, and 27I, the distribution of Si was uniform throughout the membrane without any noticeable segregation.

Shown in FIG. 28 are a series of SEM micrographs of D72T8 and D72T8(inf) membranes and the EDS Si mapping results of D72T8(inf) membrane. Similar to D80T0 and D80T0(inf) membranes, no significant microstructural difference was found between the D72T8 and D72T8(inf) membranes when examining the cross-section (FIGS. 28A and 28D), cold face (FIGS. 28B and 28E) and hot face (FIGS. 28C and 28F). Similarly, from the EDS Si mapping of the D72T8(inf) membrane shown in FIGS. 28G, 28H, and 28I, the distribution of Si was found to be uniform throughout the membrane without any noticeable segregation. Combining the EDS results of D80T0, D80T0(inf), D72T8 and D72T8(inf) membranes, the infiltration method was shown to be capable of incorporating silica particles into the PVDF-HFP membranes. However, a significant difference in Si signal intensity was found when comparing the EDS Si mapping results of separator membranes fabricated via the co-solvent method (i.e., D72T8 and D64T16) with the separator membranes fabricated using the infiltration method (i.e., D80T0(inf) and D72T8(inf)). The membranes fabricated via the infiltration method showed a stronger Si signal. Therefore, the infiltration method was more effective in incorporating silica particles into the PVDF-HFP membranes than the co-solvent method without causing any notable change in microstructure.

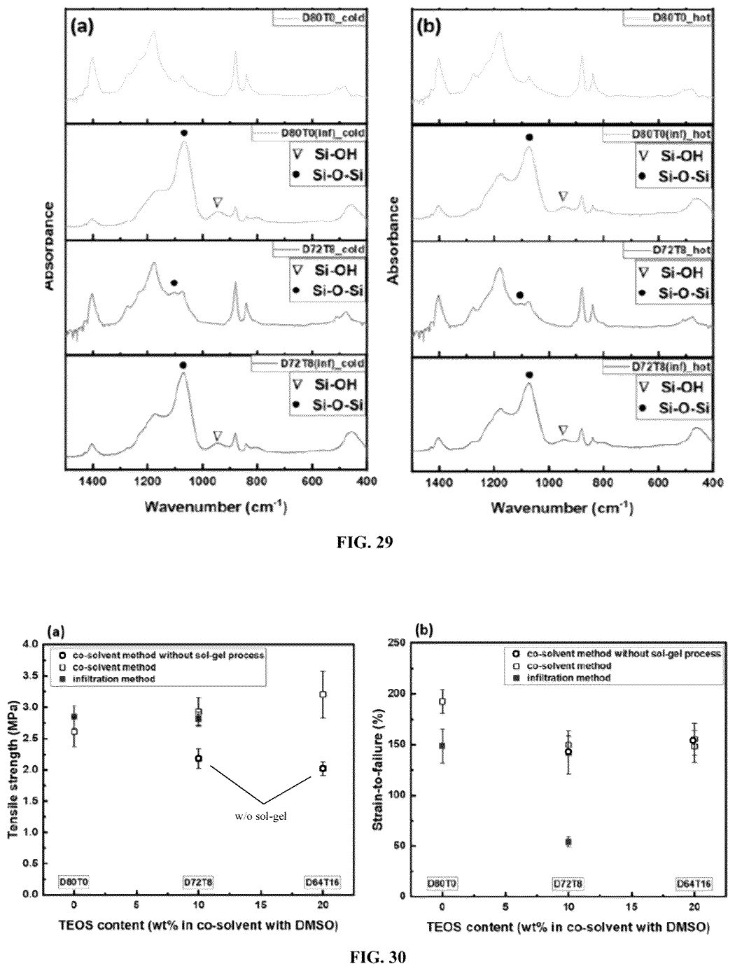

FTIR spectra of membranes prepared by the control method, the co-solvent method and the infiltration method are compared in FIG. 29. In the case of D80T0(inf) (FIGS. 29A and 29B, second row) and D72T8(inf) (FIGS. 29A and 29B, bottom row), a large peak around 1100 cm⁻¹ associated with the Si—O—Si bond and a small hump close to 950 cm⁻¹ corresponding to the silane (Si—OH) bond confirmed the incorporation of silica particles into the PVDF-HFP membranes through the infiltration method. Moreover, while comparing the FTIR spectra of D80T0(inf) and D72T8(inf) with those of D72T8 (FIGS. 29A and 29B, third row), the height of peak related to the Si—O—Si bond was larger in the membranes fabricated via the infiltration method as compared to the counterpart fabricated via the co-solvent method. This confirmed the greater effectiveness of introducing silica particles into the PVDF-HFP membranes via the infiltration method and was consistent with the EDS mapping results.

FIG. 30 depicts tensile strength and strain-to-failure of membranes fabricated via the co-solvent method with and without the sol-gel process of TEOS and the infiltration method. As can be seen in FIG. 30A, a comparison of the membranes produced with the sol-gel process of TEOS (solid squares) with those made without the sol-gel process of TEOS (open circles), a notable gap in tensile strength of the membranes was observed. This enhancement in tensile strength was attributed to the introduction of silica particles resulting from the sol-gel process of TEOS. Furthermore, while comparing the D80T0 and D72T8 membranes (open squares) with the D80T0(inf) and D72T8(inf) membranes (solid squares), no systematic difference in tensile strength was observed, which indicated that the infiltration method was not particularly conducive to strengthening the membranes.

Indeed, the infiltration method led to a sharp decrease in strain-to-failure of the membranes. This embrittlement observed in the membranes fabricated via the infiltration method was thought to be caused by the excessive silica compared to membranes fabricated via the co-solvent method. Furthermore, the strain-to-failure of membranes decreased with any addition of TEOS regardless of the sol-gel process. This decrease in strain-to-failure of membranes was likely to be attributed to the presence of large spherical pores in the D64T16 membranes and the presence of a hierarchical pore structure in the D72T8 membranes regardless of the sol-gel process. Both tend to weaken the structure of the membranes and cause membranes to fail at lower strains.

### EXAMPLE 4

### Evaluation of Four Freeze-Cast Separator Membranes

Four different separator membranes were fabricated according to the co-solvent process described Example 3 with some minor alterations as summarized in Table 2.

TABLE 2
Summary of Separator Membrane Samples.

| | | | | Thickness |
|---|---|---|---|---|
| Test ID | Name | Material | Fabrication Conditions | (μm) |
| C-102921- 70C | 20 wt % PVDF- | 20 wt % PVDF-HFP | 70° C. oil bath/cooling with | 70 |
| | HFP in DMSO | (DMSO) | LN2/Al casting plate | |
| C-102921- 160C | 20 wt % PVDF- | 20 wt % PVDF-HFP | 160° C. oil bath/cooling on RT | 40 |
| | HFP in DMSO2 | (DMSO2) | bench/Al casting plate | |
| C-121321- 64D16T | 20 wt % PVDF- | 20 wt % PVDF-HFP | 70° C. oil bath preparation, RT | 80 |
| | HFP in 64 DMSO | with silica via sol- | casting & cooling with LN2 on | |
| | & 16 TEOS, | gel of TEOS | Al casting plate | |
| C-121321- 72D8T | 20 wt % PVDF- | 20 wt % PVDF-HFP | 70° C. oil bath preparation, RT | 80 |
| | HFP in 72 DMSO | with silica via sol- | casting & cooling with LN2 on | |
| | & 8 TEOS | gel of TEOS | Al casting plate | |

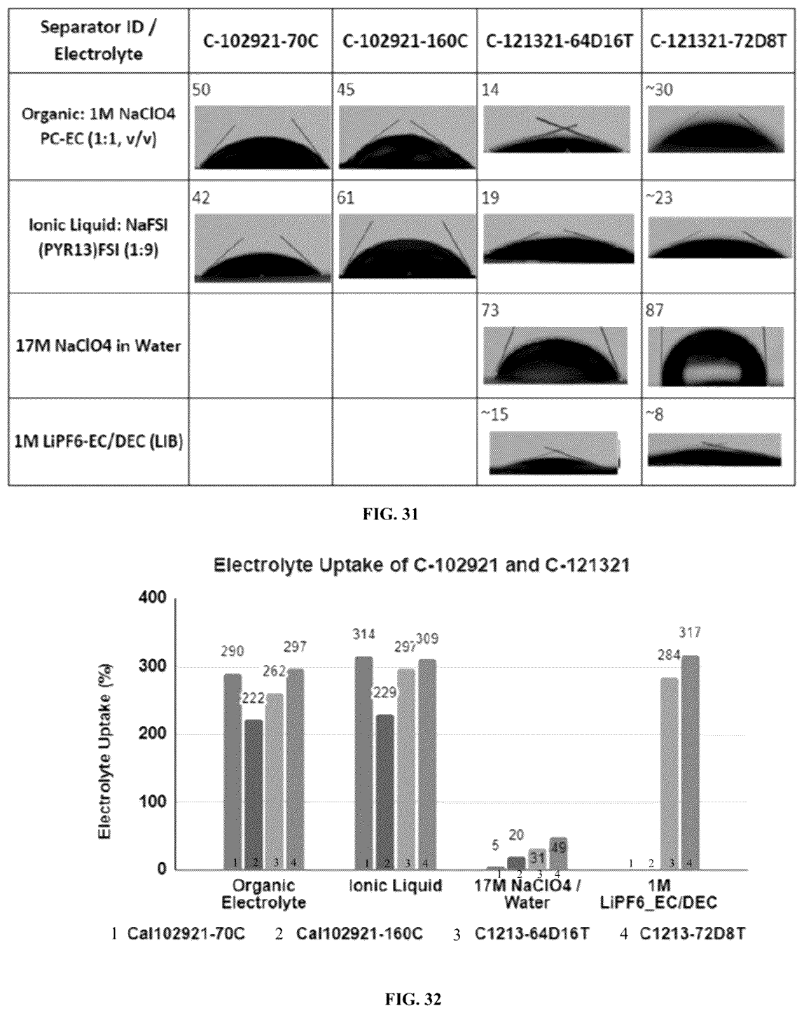

Contact angle measurements were conducted in four different electrolytes: cyclic carbonate electrolyte 1M NaClO+PC-EC (1:1, v/v), ionic liquid electrolyte NaFSI in (PYR₁₃) FSI (1:9), and high-concentrated aqueous electrolyte 17M NaClO₄ in water for sodium ion batteries; and carbonate electrolyte 1M LiPF₆ in EC/DEC (1:1, v/v) for lithium ion batteries. FIG. 31 shows the contact angle droplet images when the electrolytes were dropped onto the four separators. The pure PVDF-HFP separators (C-102921-70C and C-102921-160C) had much better wettability in both organic carbonate and ionic liquid electrolytes than Celgard PP/PE based separators. When silica was introduced into the polymer through TEOS, the PVDF-HFP-silica composite separators (C-121321-64D16T and C-121321-72D8T) showed further increased wettability with both organic carbonate and ionic liquid electrolytes. The contact angles of around 20° indicated very good wettability of the composite separators with both electrolytes. The wettability of the composite separators in a standard carbonate electrolyte for lithium ion batteries was also tested. The contact angles were quite low, implying the separators have excellent wettability for lithium ion batteries.

FIG. 32 shows the electrolyte uptake of the four separators in different electrolytes. The uptake in both organic and ionic liquid electrolytes for sodium ion batteries were in the range of 220%-315% thus confirming that freeze-cast PVDF-HFP separators are suitable for sodium ion batteries in both of the electrolytes. Additionally, the uptake of lithium ion battery electrolyte was in the range of 284%-317%, indicating that the separators are also useful for lithium ion battery system.

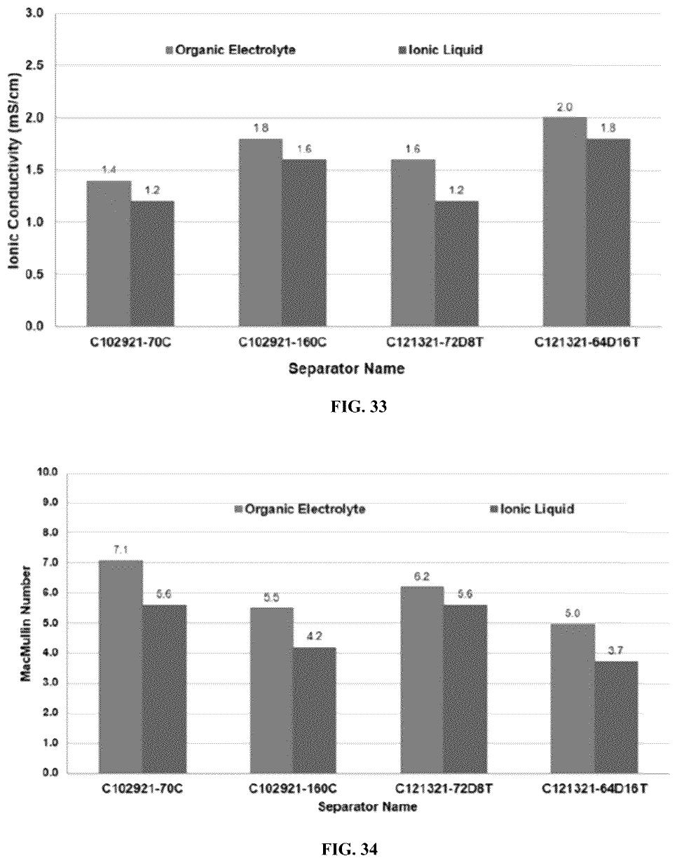

The ionic conductivity of the separator membranes was also evaluated. Membranes were soaked with electrolyte and measured by AC impedance on a cell with a configuration of stainless steel (SS) disk/separator plus electrolyte/SS disk. Electrochemical Impedance Spectroscopy (EIS) using GAMARY Interface 1010E in the frequency range of 100 Hz to 2×e6 Hz at an amplitude of 10 mV was used. The permeability of separators were assessed by the MacMullin number. FIG. 33 shows the ionic conductivities of the four freeze-cast separators in cyclic carbonate electrolyte 1M NaClO₄ PC-EC (1:1, v/v) and ionic liquid electrolyte NaFSI in (PYR₁₃) FSI (1:9). In the cyclic carbonate electrolyte, sodium ion conductivity of PVDF-HFP separator made with DSMO₂ was higher than that made with DSMO, largely because of the smaller thickness (40 μm vs 70 μm). The addition of silica in PVDF-HFP increased the ionic conductivity, even though the membrane thickness was higher (80 μm). In ionic liquid electrolyte, the same trend of ionic conductivity was observed. The separator with 16% TEOS showed the highest ionic conductivity.

FIG. 34 demonstrates the calculated MacMullin numbers for the four separators in different electrolytes. In the organic electrolyte, the PVDF-HFP separator made in DSMO₂ had better ionic permeability due to lower thickness, while the addition of silica contributed to decreased MacMullin numbers with increase of permeability. In the ionic liquid electrolyte, the same trend was observed. The lowest MacMullin number was from the PVDF-HFP-silica (16%) separator—around 3.7.

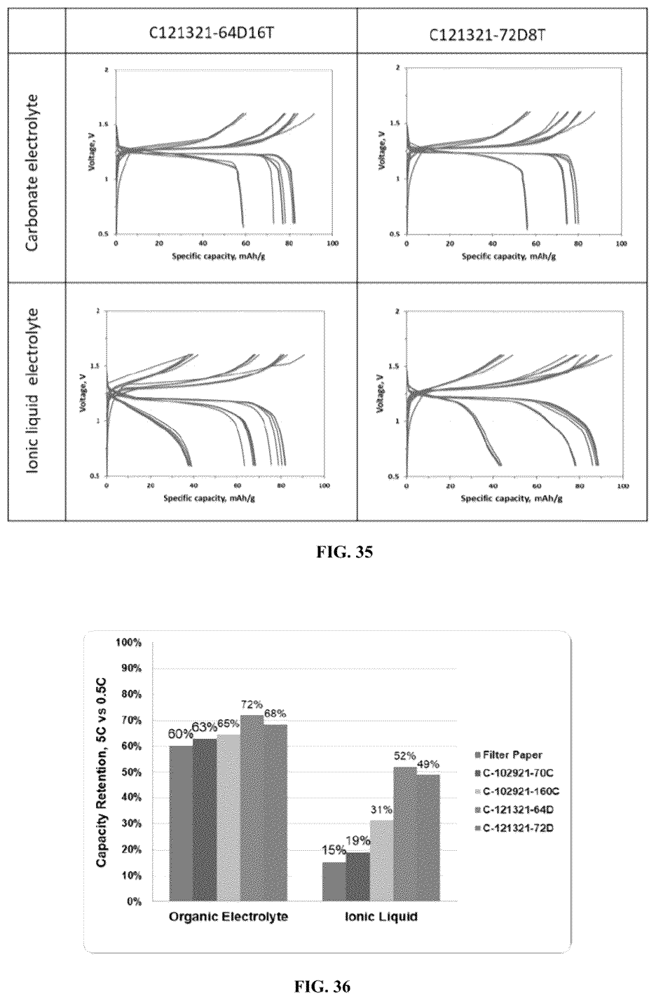

The charge-discharge test were conducted on NVP/NTP coin cells. FIG. 35 shows the charge-discharge curves of two PVDF-HFP-silica composite separators (C121321-64D16T and C121321-72D8T) in both a cyclic carbonate electrolyte IM NaClO₄ PC-EC (1:1, v/v) and an ionic liquid electrolyte NaFSI in (PYR₁₃) FSI (1:9), with a rate sequence of 0.5 C, 2 C and 5 C (5 cycles each rate) at room temperature. All cells delivered good capacities at low current, without significant difference in carbonate and ionic liquid electrolytes. FIG. 36 summarizes the capacity retention of 5 C vs. 0.5 C for all the coin cells, including the cells using filter paper and pure PVDF-HFP separators. In the organic electrolyte, the composite separator-based coin cells showed higher capacity retention, with the highest of 72% for the C121321-64D16T composite separator. In ionic liquid electrolyte, filter paper based cells were not stable and had very low performance at 5 C. The highest capacity retention (52%) was also from the C121321-64D16T composite separator.

### EXAMPLE 5

### Control of Surface Pore Size Via Two-Sided Freeze Casting

One observation of freeze-cast separator membranes is the difference of pore morphology between cold and hot surfaces, due to the difference of cooling speeds at the two sides. In order to produce separator membranes with more consistency in pore size, a novel two-sided freeze-casting method was studied for this purpose. An embodiment of the two-sided bidirectional freeze-casting method is discussed above and shown in FIG. 3C.

An LN2-chilled aluminum stage was used as the cooling source for a novel two-sided freeze-casting process with an additional top cooling source (a LN2-chilled Al plate). During the two-sided freeze-casting process, the placement of the aluminum substrate with the tape-cast film onto the LN2-chilled aluminum stage was quickly followed by the placement of the LN2-chilled aluminum plate onto the tape-cast film, in a synchronized manner. Once the freezing of the tape-cast film was complete, the sandwich structure was then immersed in a water bath at 4° C. for several minutes to allow the removal of the membrane from the sandwich structure along with the frozen DMSO in the film via solvent extraction. After complete removal of DMSO, the wet, porous PVDF-HFP membrane was removed from the water bath. The membrane was then rinsed with deionized water and ethanol and dried at RT for at least 24 hours.

The freeze-casting processes described above and summarized in FIG. 3B are one-sided. In other words, the removal of thermal energy through the cooling source is in single downward direction shown schematically in FIG. 3B. Due to the nature of the one-sided freeze casting, there exists differences in pore size on the two faces of the membranes—sub-micron pores on the cold face and micrometer pores on the hot face as shown in the Examples above. In order to create pores with similar size on both faces of the membranes, a novel two-sided freeze-casting process was adopted with the schematic shown in FIG. 3C. The two-sided freeze-casting process differed from the one-sided process in the use of an additional top cooling source—a LN2-chilled aluminum plate—and therefore allows the removal of thermal energy in both downward and upward directions.

A series of SEM micrographs of the D80T0 membranes fabricated via both one-sided and two-sided freeze casting, and the D80T0 membrane fabricated via the two-sided freeze casting followed by the infiltration method are summarized in FIG. 37. As can be seen from the cross-sections of the one-sided freeze casting (FIG. 37A), the two-sided freeze casting (FIG. 37D), and the infiltration method (FIG. 37G), the membranes all remain porous. However, the degree of directionality of pores in two-sided freeze casting appeared to decrease, which was attributed to the asymmetry involved in the setup of the two-sided freeze casting. Most importantly, the membranes fabricated via the two-sided freeze casting exhibited sub-micron pores with similar sizes on both faces as shown in FIGS. 37E and 37F. In addition, the membrane fabricated via the two-sided freeze casting followed by the infiltration method also showed pores with similar size on both faces as shown in FIGS. 37H and 37I, indicating that the infiltration method was compatible with the two-sided freeze casting.

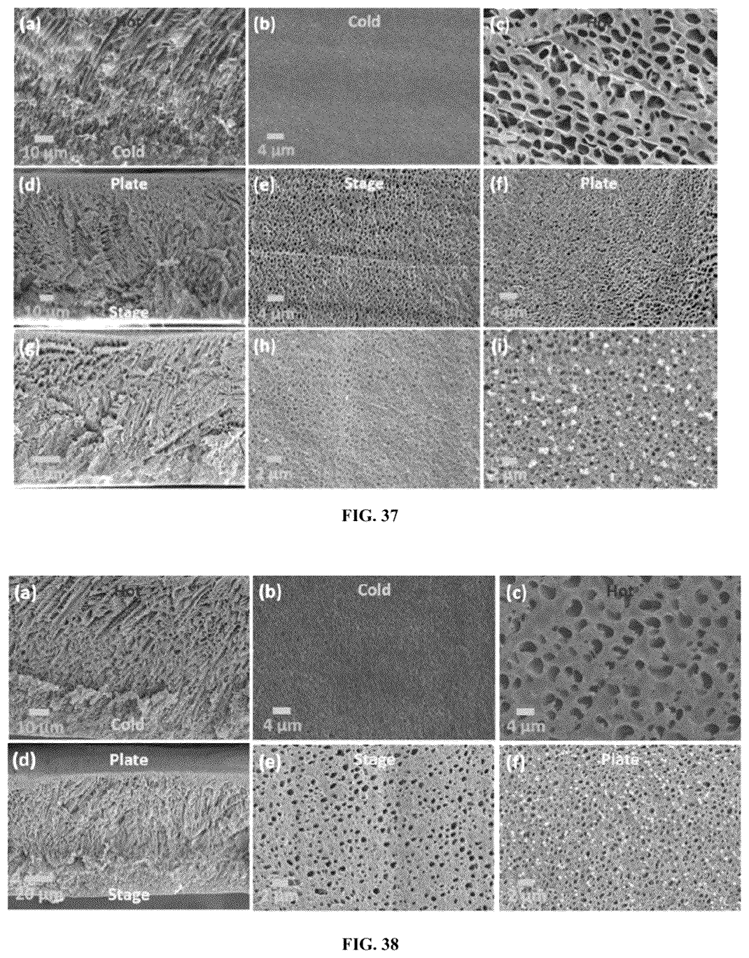

SEM micrographs of the D72T8 membrane fabricated via the one-sided freeze casting and the D72T8 membrane fabricated via the two-sided freeze casting followed by the infiltration method are summarized in FIG. 38. Similar to the previous case of the D80T0 membranes, the degree of directionality of pores appeared to decrease when moving from one-sided freeze casting (FIG. 38A) to two-sided freeze casting (FIG. 38D). Similarly, from the membrane surfaces, the membrane fabricated via the two-sided freeze casting followed by the infiltration method showed pores with similar size on both faces (FIGS. 38E and 38F) as opposed to the membrane fabricated via the one-sided freeze casting, which exhibited a significant difference in pore size on the two faces (FIGS. 38B and 38C). Based upon these results, the two-sided freeze casting method can be used to create similar pore size on both sides of the membranes. Moreover, with better temperature control in the two-sided freeze casting, the degree of directionality of pores can be retained as in the case of one-sided freeze casting.

### EXAMPLE 6

### Lab-Scale Bidirectional Freeze-Cast Methods

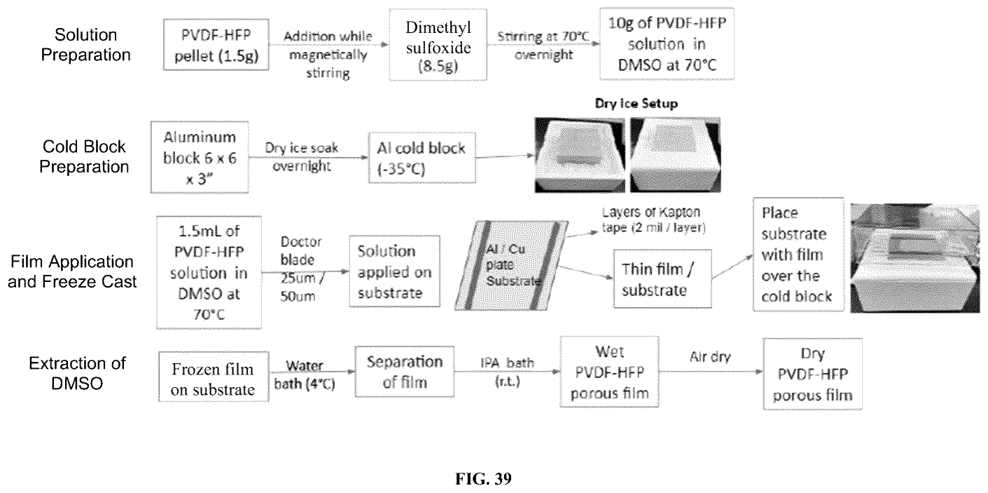

Shown in FIG. 39 is the general procedure to freeze cast PVDF-HFP separator membranes using dry ice. The detailed procedures are as follows:
(1) Two solutions of poly(vinylidene fluoride-co-hexafluoropropylene) (PVDF-HFP) in Dimethyl sulfoxide (DMSO) were prepared at 15%/85% and 20%/80% PVDF-HFP/DMSO. Solutions of PVDF-HFP, DMSO and tetraethyl orthosilicate (TEOS) with respective amounts of 20%/72%/8% were also prepared. The components were added to a vial, heated to about 70° C. , and stirred overnight. The solution was then placed in an oven at 70° C.
(2) About 1.5 ml of the solutions was tape cast onto metal substrates. The substrates consisted of various alloys of aluminum and copper (Al 1100, Al 3003, Al 6061, Cu 110). The substrates were of various thicknesses between 0.016 inches and 0.025 inches. The tape-cast thickness was adjusted using a combination of a fixed-setting doctor blade and layers of Kapton. Tape-cast thicknesses were varied between 4 mil and 12 mil. The substrates and doctor blade were at room temperature, while the solution was at 70° C. when cast.
(3) After tape casting, the substrates were immediately placed in contact with an aluminum cold-finger. The substrate made contact with the cold-finger along one edge. An air wedge was supported under the substrate via a certain height of polycarbonate between the opposite edge of the substrate and the aluminum cold-finger. The height of the polycarbonate was varied between 0 mm and 3.2 mm.
(4) The low temperature of the aluminum cold-finger was achieved via two different methods. In the first method, the aluminum cold-finger was soaked in a refrigerated cold-chamber for about 2 hours at −25° C. The cold-finger was removed from the chamber right before contact with the substrate/tape-cast solution. In the second method, the cold-finger was soaked overnight in dry ice. Then, during casting, the cold-finger was surrounded by dry ice around the sides with the top surface exposed, and insulated with Styrofoam. The second method yielded a more consistent temperature around −30° C.
(5) After complete freezing of the tape-cast solution, the substrate and film were immersed in a water bath and maintained at less than about 10° C. to dissolve the frozen DMSO out of the film. For the samples that contained TEOS, after the solvent exchange, the film was soaked overnight in a bath of ethanol and ammonium hydroxide (20:1, vol:vol) for completion of the sol-gel process. The films were then rinsed in an isopropanol bath for several minutes, then dried in air at room temperature for at least 24 hours. Steel mesh was used to keep the films submerged. The cold-finger temperature was achieved via the first method (cold chamber) for all TEOS composite samples. For the samples that did not contain TEOS, after the solvent exchange, the films were removed from the water bath and rinsed in an isopropanol bath for several minutes, then dried in air at room temperature for at least 24 hours. Steel mesh was used to keep the films submerged. The cold-finger temperature was achieved via the second method (dry ice) for all the samples not containing TEOS.

A thermal gradient study was carried out to understand the freezing behavior during the process. PVDF-HFP/DMSO solutions during lab-scale dry ice freeze-cast methods had frequently shown results of incomplete freeze fronts towards the top of the film. In forming a shiny, wet top layer, while rapidly collecting moisture from the surrounding air, surface temperatures nearest to the spacer and up the air wedge along the cold finger in dry ice have resulted in challenges in freezing the remaining solution. Consequently, incomplete freezing can lead to layer separation and non-uniform surfaces. A thermal gradient study was conducted in the dry ice set up, marking 5 points. Each of the 5 points were one-inch apart on the substrate (aluminum 6″×6″×0.032″) as it is positioned atop the cold finger with an air wedge. A laser infrared thermometer gun was then pointed at each mark consecutively in one direction to record the temperature across the substrate for about 10-15 seconds: this is considered one round. Between each round, there was about 5-10 seconds rest, then temperature monitoring was resumed for the same duration as the previous round. This cycle was repeated simultaneously until roughly 150-180 seconds of the test passed.

The data showed that immediate contact of the substrate to the cold finger introduced roughly 20° C. into the freeze cast that then rapidly dropped over time across the gradient. Points closer to the air wedge at the top showed a slightly slower decrease in temperature due to the conductivity of the spacer. The height of the spacer selected was also another factor that decreased contact between the substrate and cold finger. As a result, casting the samples onto the substrate further away from the spacer may help improve freezing, while considering lower spacer heights to ensure optimal surface contact.

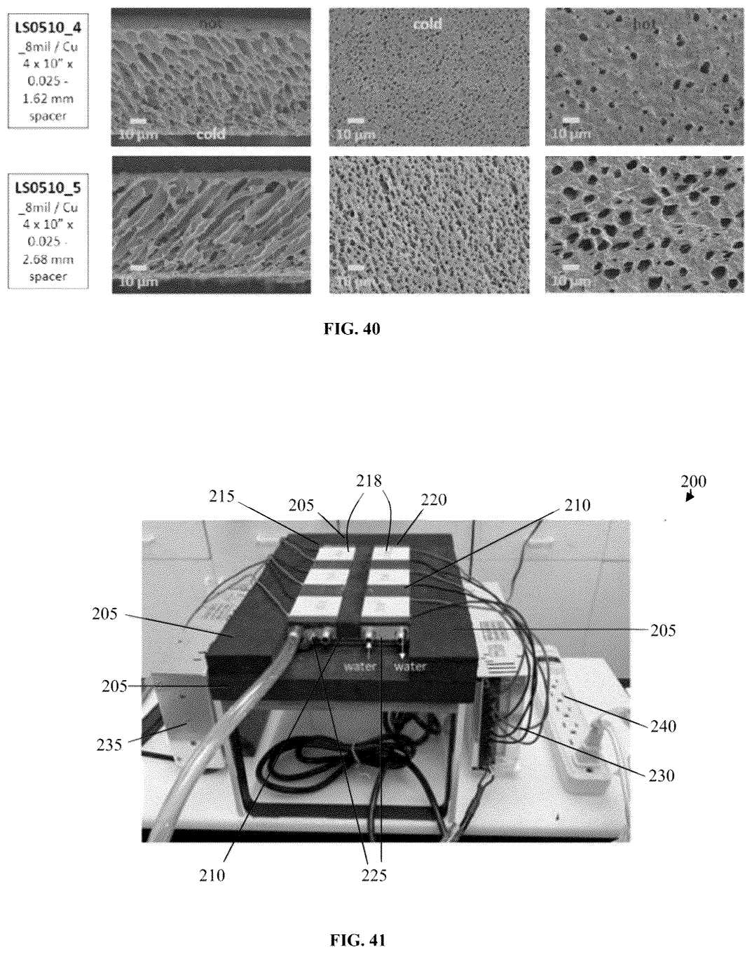

There was a thermal gradient along the freezing direction. The result showed that 1) the temperatures at the freezing front for any thickness of spacer fluctuated instead of decreasing gradually with increasing time. This may have been due to the cold air blowing from dry ice in the box through the gap between the cold block and the box cover surrounding the block; 2) the temperature increased across the freezing direction because the air wedge height between the substrate and the cold block increased closer to the spacer; 3) The temperature-time curves at different checkpoints were close to each other along the freezing direction when the spacer thickness was reduced to 0.5 mm or 1.1 mm. Little thermal gradient was observed when using thinner spacers. The vertically aligned pore structures for each are shown in FIG. 40.

To lower the temperature of the cold finger and decrease pore size, liquid nitrogen (LN2) was used to cool the fold fingers instead of dry ice. The base of the cold finger was composed of an aluminum stage (165 mm×162 mm×87 mm) in a Styrofoam container. The base was pre-chilled by soaking the aluminum stage in liquid nitrogen (LN2). The aluminum block took approximately 30 minutes to reach thermal equilibrium with the LN2 reservoir. The secondary “top cold finger” was composed of a slightly smaller aluminum block (165 mm×162 mm×38 mm), which could be lifted out of a cold reservoir and placed on top of the sample to provide dual cold source freeze-casting process (i.e. the two-sided LN2 sandwich method). The top block was pre-chilled by soaking the aluminum stage in liquid nitrogen (LN2) in a separate Styrofoam reservoir. The top aluminum block also took approximately 30 minutes to reach thermal equilibrium with the LN2 reservoir.

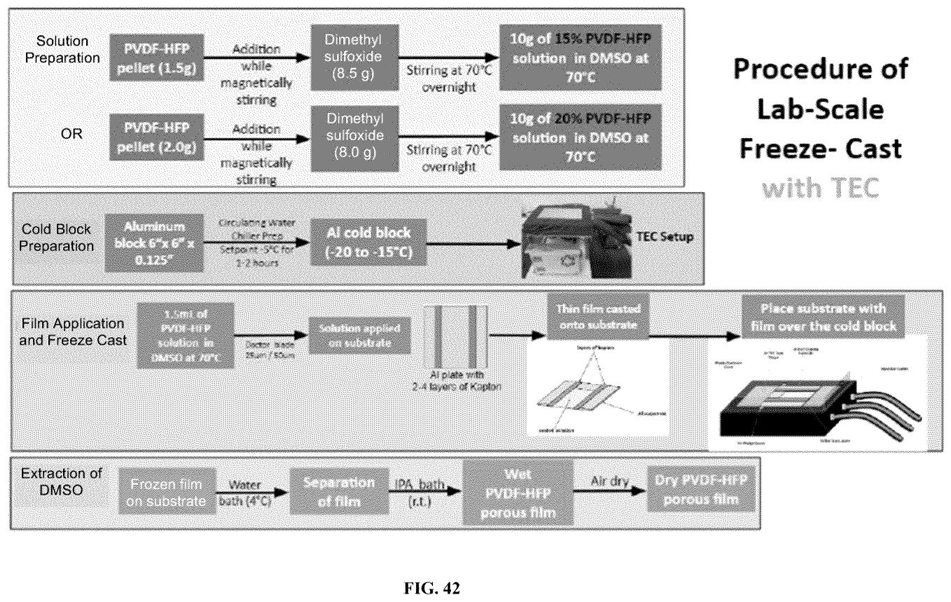

A thermoelectric cooling (TEC) system was developed as shown in FIG. 41. The TEC system 200 includes adhesive Neoprene foam sheets 205 for insulation. A series of 20 mm×20 mm×3.7 mm TECs (Peltier TEC1-12706) were used for cooling. As shown in FIG. 41, there were three TECs 215 on the left and three TECs 220 on the right. In some embodiments, the number of TECs was increased to 8 or more. The TECs 215, 220 were disposed on top of a pair of aluminum water cooling blocks 225. The aluminum water cooling blocks 225 were disposed on top of a 2 inch thick rubber sheet. The TECs 215, 220 and aluminum water cooling blocks 225 were attached together using thin layers of self-adhesive rubber sheets 210. On each TEC 215, 220 was a 4 in.×8 in.×⅛ in. aluminum plate 218 to serve as the cold finger/freezing stage. In other embodiments, the aluminum plate 218 is 0.5 inches thick. The aluminum water cooling blocks 225 were hooked up to a 30-liter USA LAB circulator chiller (not shown). The solution of propylene glycol (C₃H₈O₂) and distilled water (50:50) were used as liquid media for the chiller to achieve circulation of lower temperatures within the system. The TEC system 200 also includes two 12 volt DC power supplies 230, 235 to power the left and right row of TECs 215, 220, respectively. The DC power supplies 230, 235 are attached to power strip 240. In some embodiments, additional foam insulation is added around the TEC assembly to provide a four-sided shield and allow a clear acrylic sheet to be used as a cover to place over the cold fingers and minimize moisture absorption from the surrounding air during the freeze-casting process. The TEC array is designed to provide a chilling temperature as low as about −40° C. or even −50° C. FIG. 42 depicts a flow chart summarizing the tape and bidirectional freeze-casting process used with the TEC assembly.

We claim:

1. A separator membrane produced from a freeze-cast solution, the separator membrane comprising:
at least one polymer;
a total porosity of at least about 50%; and
a plurality of vertically-aligned pore structures, wherein greater than about 75% of the vertically-aligned pore structures comprise a height that is greater than its diameter, and wherein each of the vertically-aligned pore structures have a pore diameter of less than about 2 μm at a membrane surface.

2. The separator membrane of claim 1, wherein:
(i) greater than 95% of the vertically-aligned pore structures comprise a height that is greater than their diameter; or
(ii) the separator membrane comprises a top surface and a bottom surface, wherein each of the top surface and the bottom surface comprises a plurality of vertically-aligned pore structures, wherein each of the vertically-aligned pore structures have a pore diameter of less than about 1 μm at the top membrane surface, the bottom membrane surface, or both the top membrane surface and bottom membrane surface; or
(iii) both (i) and (ii).

3. The separator membrane of claim 1, wherein the freeze-cast solution comprises between about 10% by wt and about 40% by wt polymer.

4. The separator membrane of claim 1, wherein the polymer is selected from the group consisting of polyvinylidene fluoride (PVDF), poly(vinylidene fluoride-co-hexafluoropropylene (PVDF-HFP), polyimide, polyamic acid, polyolefin, polytetrafluoroethylene, polyvinyl chloride, polypropylene, polyethylene, polyethylene terephthalate, polyacrylonitrile, and a combination thereof.

5. The separator membrane of claim 1, wherein the freeze-cast solution comprises between about 0.5% by wt and about 25% by wt ceramic particles selected from the group consisting of SiO₂, Al₂O₄, TiO₂, ZrO₂, MgO, Li₂La₃Zr₂O₁₂ (LLZO), and a combination thereof.

6. The separator membrane of claim 5, wherein the freeze-cast solution comprises between about 0.75% by wt and about 3% by wt Al₂O₃ or between about 8% by wt and about 16% by wt tetraethyl orthosilicate (TEOS).

7. The separator membrane of claim 6, wherein the separator film comprises a polymer matrix and the ceramic particles were embedded into the polymer matrix by infiltration following freeze casting.

8. The separator membrane of claim 1, further comprising a membrane thickness of between about 10 μm to about 100 μm.

9. The separator membrane of claim 1, wherein the total porosity is at least about 60%.

10. The separator membrane of claim 1, further comprising: (i) a tensile strength of at least about 5 MPa according to ASTM-D882; (ii) a MacMullin number of less than about 5 in an ionic liquid; or (iii) both (i) and (ii).

11. The separator membrane of claim 1, disposed within a sodium ion battery cell.

12. A separator membrane produced from a freeze-cast solution, the separator membrane comprising:
a total porosity of at least about 60%;
a thickness of about 10 μm to about 100 μm; and
a plurality of vertically-aligned pore structures, wherein each of the vertically-aligned pore structures have a pore diameter of less than about 1 μm on at least one membrane surface, and wherein greater than about 75% of the vertically-aligned pore structures comprise a height that is greater than their diameter;
wherein the freeze-cast solution comprises between about 10% by wt and about 40% by wt polymer selected from the group consisting of polyvinylidene fluoride (PVDF), poly(vinylidene fluoride-co-hexafluoropropylene (PVDF-HFP), polyimide, polyamic acid, polyolefin, polytetrafluoroethylene, polyvinyl chloride, polypropylene, polyethylene, polyethylene terephthalate, and polyacrylonitrile, and a combination thereof.

13. The separator membrane of claim 12, wherein the separator membrane comprises a top surface and a bottom surface, wherein each of the top surface and the bottom surface comprise a plurality of pores having a diameter of less than about 1 μm.

14. The separator membrane of claim 12, wherein:
(a) the freeze-cast solution comprises between about 0.5% by wt and about 25% by wt ceramic particles selected from the group consisting of SiO₂, Al₂O₃, TiO₂, ZrO₂, MgO, garnet Li₇La₃Zr₂O₁₂, and a combination thereof; or
(b) the ceramic particles were embedded into a polymer matrix of the separator film by infiltration following freeze casting, wherein the ceramic particles are selected from the group consisting of SiO₂, Al₂O₃, TiO₂, ZrO₂, MgO, garnet Li₇La₃Zr₂O₁₂, and a combination thereof; or (c) both (a) and (b).

15. The separator membrane of claim 14, wherein the freeze-cast solution comprises between about 0.75% by wt and about 3% by wt Al₂O₃ or between about 8% by wt and about 16% by wt tetraethyl orthosilicate (TEOS), and wherein the vertically-aligned pore structures comprise a plurality of secondary pores.

16. A method of producing the separator membrane of claim 1, the method comprising:
(a) preparing a polymer solution comprising at least one polymer and at least one solvent;
(b) tape casting the polymer solution to produce a tape cast polymer film;
(c) freeze casting the tape-cast polymer film on a freezing stage at a temperature from about 20° C. to about −200° C. to provide a freeze-cast polymer film between about 1 mil and about 15 mil thick; and
(d) extracting the solvent from the freeze-cast polymer film to produce a separator membrane with vertically aligned pores.

17. The method of claim 16, wherein the polymer solution is heated until homogeneous and the tape casting comprises disposing the polymer solution on a substrate selected from the group consisting of aluminum, copper, glass, and stainless steel.

18. The method of claim 16, wherein the freeze casting comprises disposing the tape-cast polymer film and substrate on the freezing stage, wherein the freezing stage comprises a thermally conductive material having a thermal conductivity of between about 80 W/m·K and about 300 W/m·K, and wherein the freezing stage is pre-chilled at a temperature range from about −20° C. to about −200° C. or about −40° C. to about −190° C.

19. The method of claim 16, further comprising a spacing component disposed on one end of the freezing stage, wherein the tape-cast polymer film and substrate are disposed on the freezing stage with one end of the substrate contacting the freezing stage directly with an opposite end disposed on the spacing component to create an angled air wedge between the substrate and freezing stage, and wherein the angled air wedge comprises an upward angle between about 0° and about 30°.

20. The method of claim 16, further comprising:
(e) soaking the freeze-cast separator membrane in a solution containing ceramic particles for at least about 12 hours, and
wherein the freeze-case separate membrane is subjected to a sol-gel process before step (e), after step (e), or both before and after step (e)
